(19) United States
(12) Patent Application Publication
(10) Pub. No.: US 2024/0343942 A1
(43) Pub. Date: Oct. 17, 2024

(54) CURABLE SILOXANE-MODIFIED RESIN COMPOSITIONS WITH SILICONE-OIL ADDITIVES AND USE THEREOF

(71) Applicant: NDSU RESEARCH FOUNDATION, Fargo, ND (US)

(72) Inventors: Dean C. WEBSTER, Fargo, ND (US); Morgen J. HAGEROTT, Fargo, ND (US); Ramsharan PANDEY, Fargo, ND (US); Shokoofeh GHASEMI, Fargo, ND (US)

(21) Appl. No.: 18/615,593

(22) Filed: Mar. 25, 2024

Related U.S. Application Data
(60) Provisional application No. 63/492,142, filed on Mar. 24, 2023.
(60) Provisional application No. 63/492,144, filed on Mar. 24, 2023.

(51) Int. Cl. C09D 183/04; C08G 77/00; C09D 5/16; C09D 7/65; C09D 163/00; C09D 175/02

(52) U.S. Cl. CPC C09D 183/04; C09D 5/1675; C09D 7/65; C09D 163/00; C09D 175/02; C08G 77/80

(57) ABSTRACT

The invention relates to a curable coating composition comprising: a) at least one siloxane-modified resin composition; b) at least one silicone oil additive; c) optionally, at least one further additive; d) optionally, at least one catalyst; and e) optionally, at least one solvent. The invention also relates to a cured coating composition, comprising the curable coating composition. The invention also relates to an article of manufacture, comprising: a) a substrate; and b) the curable coating composition applied on at least a part of the surface of the substrate. The invention also relates to a method of coating a substrate comprising: providing a substrate; applying the curable coating composition on at least a part of the surface of the substrate to form a coated substrate; and curing the coated substrate under conditions sufficient to cure the curable coating composition.

### CROSS-REFERENCE TO RELATED APPLICATIONS

This application claims priority to U.S. Provisional Application No. 63/492,142, filed Mar. 24, 2023, and U.S. Provisional Application No. 63/492,144, filed Mar. 24, 2023, the disclosures of which are incorporated herein by reference.

### STATEMENT OF U.S. GOVERNMENT SUPPORT

This invention was made with government support under grants N00014-20-1-2817 and N00014-22-1-2129 awarded by the Office of Naval Research. The U.S. government has certain rights in the invention.

### BACKGROUND OF THE INVENTION

A significant challenge for the military, transportation, and energy industries is snow/ice accumulation. Ice accretion on the surfaces of transmission lines, wind turbines, airplanes, and ships can have a multitude of detrimental effects ranging from safety issues to catastrophic failures. Ice and snow accretion on transmission lines can cause power failure while ice accretion on wind turbines can lower energy generation. Ice accretion on an aircraft can have catastrophic effects. Ice can interfere with flight control mechanics or worse, hinder the generation of lift. Furthermore, ice accretion on the surface of airplanes and ships significantly increases drag and reduces fuel efficiency in addition to safety issues. On wind turbines, ice accretion can create imbalances between the turbine blades, leading to inefficiency or potential failure. Ice accretion on power lines can cause straining on the line and eventual snapping. Ice accretion on a ship's superstructure can fall, posing a serious risk of injury or death to crew members. As naval ships and transportation vessels move further north into arctic shipping lanes, ice mitigation strategies will become more important for efficiency and safety. Delaying the formation and easy removal of ice from these surfaces is very important for safety, reliability, and proper functioning. Active methods of ice removal include mechanical scrubbing, heating, and spraying of deicing chemicals. These methods are very time-consuming, costly, and not long-lasting. The run-off of deicing chemicals on water and soil can have detrimental effects on aquatic ecosystems and soil fertility, respectively. Therefore, passive preventive measures have been explored in recent years. Passive preventive measures include the application of coatings on the surface. The coatings on the surface should either delay the formation of ice or it should have very low adhesion such that ice can be easily removed, either by its own weight or slight external force. The coating's surface should also be durable, and its ice adhesion property should not diminish significantly over time. However, ice adhesion is a complex phenomenon, and several factors affect the adhesion of ice on a coating surface including surface properties, modulus, coating thickness, porosity, roughness, and crosslink density. Different epoxy and icephobic coatings have been explored including coatings with textured hydrophobic surfaces, low surface energy coatings, heterogeneous/amphiphilic coatings, and liquid-infused layers.

Epoxy coatings remain a critical technology used in many industries. They are used for the protection and decoration of various materials such as metals, wood, and concrete. The main utility of epoxy coatings comes from their durability, chemical resistance, and corrosion prevention. In addition to coating applications, epoxies are a popular flooring material, where they provide long lasting protection from impact, abrasion, and harsh substances. The most commonly used epoxy resin bisphenol-A, and other aromatic epoxies, are vulnerable to weather, specifically when exposed to ultraviolet (UV) radiation. The aromatic rings absorb UV radiation which leads to degradation of the coating. To protect the decorative finish of epoxy coatings that are exposed to UV, a top coating can be added to shield the epoxy from direct exposure. This top coating is commonly a durable polyurethane. However, the synthesis of polyurethanes requires the handling of toxic isocyanates, so efforts have been made to avoid using these coatings. Beyond this, the problem with the two-part solution is that it involves applying multiple coats, increasing material and application costs. Thus, an ongoing goal is to find a way to combine these properties into a single coating system.

Epoxy-siloxane coatings are a relatively new technology that incorporate the durability of epoxy resins with the weather resistance of silicones. This is a desirable coating system that avoids the additional cost of using a topcoat to provide the desired level of protection. Epoxy-siloxane coatings are generally comprised of a non-aromatic epoxy resin, an organosilane, a polysiloxane, and an aminoalkylsilane. The amine groups of the aminoalkylsilane react with the epoxy through an epoxy-amine reaction, and the silane groups react with the organosilane and polysiloxane through hydrolytic polycondensation, creating a crosslinked epoxy-siloxane coating. The benefit of this system is a highly durable coating, which is weather resistant due to the selection of an aliphatic/cycloaliphatic epoxy resin and the siloxanes present.

Superhydrophobic surfaces (SHS) include micro and nano-textured roughness with low surface-free energies which prevent water retention on the surface by sliding or bouncing of water droplets. These surfaces do not always act as icephobic surfaces, for example, in high humidity environments, water vapor can rapidly freeze on the micro/nanotextured surfaces and form ice crystals and start accumulating ice layers. These kinds of surfaces promote heterogeneous nucleation of ice crystals. These ice layers are harder to remove due to mechanical interlocking on the rough surface and ice adhesion can be several magnitudes higher than the smooth hydrophobic surfaces. Another drawback of SHS is their poor durability as the micro/nano textures can be easily destroyed by small mechanical forces like icing/deicing processes. Slippery liquid-infused porous surfaces (SLIPS) are another strategy for anti-icing applications where the slippery hydrophobic liquid is entrapped inside a porous matrix and on the surface which acts as a lubricating layer that prevents ice accumulation. However, this method lacks long-term durability due to the need for replenishment of the lubricant over time due to washing away. Several elastic coating materials have been explored for anti-icing applications due to their low ice adhesion property. In such materials, cross-link density and plasticization are lowered to reduce ice adhesion strength. However, this also reduces their mechanical properties like toughness and thus their durability. The fundamental challenge with icephobic coatings is maintaining low ice adhesion and robust mechanical properties over time. Therefore, it is essential to control both the bulk and surface properties of these coatings to ensure mechanical durability as well as ice-shedding properties.

Ships also face the issue of fouling. Biofouling is the buildup of marine organisms on a surface that is in the water. There are over 4,000 known marine organisms capable of fouling. This makes mitigation methods quite difficult. Biofouling consists of micro-organisms such as bacteria and algae up to macro-organisms like barnacles and mussels. Uncontrolled biofouling can lead to increased drag, accelerated corrosion, and the transfer of invasive species to other ecosystems. Previously, coatings containing biocides, such as tributyltin oxide, were used to prevent the accumulation of biofouling. These coatings were successful in preventing the attachment of marine organisms, but it was later discovered that they were harming the surrounding ecosystem. In 1980, the International Maritime Organization banned the use of these coatings. This led to the development of non-toxic fouling release coatings. Silicone oil additives in a silicone elastomer became popular as a non-toxic ship hull coating. The presence of silicone oil creates a lubricating layer that prevents strong attachment of marine organisms and allows for easy removal. Incorporation of amphiphilic silicone oil creates a heterogenous surface that makes the attachment of marine organisms more difficult.

Silicone oil additives are also used for creating icephobic coatings. Like the fouling release coatings, the silicone oil at the surface lowers the adhesion of ice. Similarities have been identified between ice releasing properties and fouling releasing properties. There has been little overlap between these two coating technologies. Upadhyay et al. (“Amphiphilic icephobic coatings,” Progress in Organic Coatings 2017, 112, 191-199) conducted an ice adhesion study on a series of amphiphilic coatings that had been characterized using biofouling assays. Some of the coatings that performed well against biofouling also exhibited icephobic characteristics. When using amphiphilic additives, the balance between each moiety is crucial in determining the ice/fouling releasing properties of the material. The findings are promising but need to be researched further to better understand how each moiety is affecting the ice and fouling that attach to the surface.

There is a need, therefore, for coatings systems with improved ice-adhesion and anti-fouling properties. The present invention solves this need.

### SUMMARY OF THE INVENTION

The invention relates to a curable coating composition comprising, consisting essentially of, or consisting of:
a) at least one siloxane-modified resin composition;
b) at least one silicone oil additive;
c) optionally, at least one further additive;
d) optionally, at least one catalyst; and
e) optionally, at least one solvent.

The invention also relates to a cured coating composition, comprising, consisting essentially of, or consisting of the curable coating composition of the invention.

The invention also relates to an article of manufacture, comprising, consisting essentially of, or consisting of:
a) a substrate; and
b) the curable coating composition of the invention applied on at least a part of the surface of the substrate.

The invention also relates to a method of coating a substrate comprising:
providing a substrate;
applying the curable coating composition of the invention on at least a part of the surface of the substrate to form a coated substrate; and
curing the coated substrate under conditions sufficient to cure the curable coating composition.

### BRIEF DESCRIPTION OF THE FIGURES

FIG. 1 shows the ATR-FTIR of methyl and phenyl dominant polysiloxane coatings.

FIG. 2 shows the static water contact angle of oil-containing coating formulations and the base.

FIG. 3 shows the surface energy of oil-containing coating formulations and the base.

FIG. 4 shows the ice adhesion of 1 cm×1 cm pieces of ice on unmodified and modified epoxy-siloxane coatings.

FIG. 5 shows the critical force vs critical length of a select group of polysiloxane modified coatings.

FIG. 6 shows the interfacial toughness siloxane oil modified coatings.

FIG. 7 shows the N. incerta leachate solution toxicity of sample and commercial coatings.

FIG. 8 shows the N. incerta cell attachment and cells remaining after water jet cleaning.

FIG. 9 shows the C. lytica leachate toxicity in solution (top) and on coating surface (bottom).

FIG. 10 shows the C. lytica biofilm growth and biofilm remaining after water jet removal.

FIG. 11 shows the barnacle adhesion of modified epoxy-siloxane coatings and the commercial coating Intersleek 1100SR.

FIG. 12 shows the miscibility predictions of silicone oils in epoxy-siloxane matrix.

FIG. 13 shows the result of ice adhesion test of coatings with different oil additives.

FIG. 14 shows the result of contact angles test of coatings with different oil additives.

FIG. 15 shows the result of surface free energy test of coatings with different oil additives.

FIG. 16 shows the AFM images with phase and height images for coatings with different oil additives (a: F-4 with 5% DM-100-185; b: F-13 with 1% PMDM-010-125; c: F-15 with 6.5% PMDM-010-125); top image represents the height and bottom image represents phase image.

FIG. 17 (a)-17 (c) shows the ice adhesion (FIG. 17 (a)), contact angle (FIG. 17 (b)), and surface free energy (FIG. 17 (c)) tests for coatings with DOWSIL 3074 resin.

### DETAILED DESCRIPTION OF THE INVENTION

The invention relates to a curable coating composition comprising, consisting essentially of, or consisting of:
a) at least one siloxane-modified resin composition;
b) at least one silicone oil additive;
c) optionally, at least one further additive;
d) optionally, at least one catalyst; and
e) optionally, at least one solvent.

The siloxane-modified resin composition (a) may be selected from an epoxy-siloxane resin composition, polyurea-siloxane resin composition, and mixtures thereof.

The epoxy-siloxane resin composition may comprise, consist essentially of, or consist of:
a1) at least one epoxy resin;
a2) at least one silane compound; and
a3) at least one silicone resin.

The at least one epoxy resin (a1) may be any epoxy functional resin, including, without limitation, a bisphenol-A epoxy resin, glycidyl ethers of bisphenol-A, bisphenol-F, tetramethyl bisphenol-A, tetramethyl bisphenol-F, hydrogenated bisphenol-A, phenolic resin, butane diol, hexane diol, cyclohexane dimethanol, trimethylolpropane, and the like. For example, the epoxy resin may be a bisphenol-A epoxy resin, such as a hydrogenated bisphenol-A (e.g., Eponex 1510). The at least one bisphenol-A epoxy resin may have a viscosity at 25° C. ranging from about 1800-2500 cps (e.g., 1900-2400 cps, 2000-2300 cps, 2100-2200 cps).

The at least one silane compound (a2) may be, without limitation, (3-aminopropyl) trimethoxysilane, methyltrimethoxysilane, and N-butylaminopropyltrimethoxysilane.

The at least one silicone resin (a3) may be, for example, a methoxy-functional silicone resin, such as DOWSIL DC-3074 and SILRES SY 231. The methoxy-functional silicone resin may have a viscosity at 25° C. of about 90-180 sCt (e.g., 100-170 sCt, 110-160 sCt, 120-150 sCt, 130-140 sCt) and a molecular weight average ranging between 900-1900 Daltons (e.g., 1000-1800 Daltons, 1100-1700 Daltons, 1200-1600 Daltons, 1300-1500 Daltons). For example, epoxy-siloxane resin compositions that may be used in the invention include those disclosed in U.S. Pat. No. 5,618,860, the disclosure of which is incorporated herein by reference.

The at least one epoxy resin (a1) may be present in the epoxy-siloxane resin composition in an amount ranging from about 30-60 wt. % (e.g., 35-55 wt. %, 40-50 wt. %, 45-48 wt. %), based on the total weight of the epoxy-siloxane resin composition. The at least one silane compound (a2) may be present in the epoxy-siloxane resin composition in an amount ranging from about 0.1-10 wt. % (e.g., 0.5-8 wt. %, 1-5 wt. %, 2-4 wt. %), based on the total weight of the epoxy-siloxane resin composition. The at least one silicone resin (a3) may be present in the epoxy-siloxane resin composition in an amount ranging from about 35-70 wt. % (e.g., 40-65 wt. %, 45-60 wt. %, 50-55 wt. %), based on the total weight of the epoxy-siloxane resin composition.

The polyurea-siloxane resin composition may comprise, consist essentially of, or consist of:
b1) at least one alkoxy silane functional polyurea resin; and
b2) at least one silicone resin.

The alkoxy silane functional polyurea resin (b1) may comprise, consist essentially of, or consist of the reaction product of:
b1.1) at least one polyisocyanate resin; and
b1.2) at least one amino-functional alkoxy silane and, optionally, at least one difunctional amine,
   wherein the components (b1.1) and (b1.2) are reacted under conditions sufficient to form the alkoxy silane functional polyurea resin.

The at least one polyisocyanate resin (b1.1) may be aliphatic polyisocyanates selected from the group consisting of aliphatic polyisocyanate based on HDI trimer, aliphatic polyisocyanate based on HDI uretdione, aliphatic polyisocyanate based on HDI biuret, aliphatic polyisocyanate based on HDI allophanate trimer, aliphatic polyisocyanate based on asymmetric HDI trimer. Preferably, the aliphatic polyisocyanate is Desmodur N 3600. For example, polyisocyanate resins (b1.1) that may be used include those disclosed in U.S. Pat. Nos. 8,133,964, 9,139,753, and 9,221,942, the disclosures of which are incorporated herein by reference.

The at least one amino-functional alkoxy silane (b1.2) may be substituted at the N-position with a group selected from C3-C6 alkyl, cyclohexyl, and phenyl. For example, the amino-functional alkoxy silane may be selected from the group consisting of N-butyl-3-aminopropyltrimethoxysilane, N-butyl-3-aminopropylmethyldimethoxysilane, N-butyl-3-aminopropyltriethoxysilane, N-ethyl-3-aminopropyltriethoxysilane, N-cyclohexyl-3-aminopropyltrimethoxysilane, N-phenyl-3-aminopropyltrimethoxysilane, N-hexyl-3-aminopropyltrimethoxysilane, N-pentyl-3-aminopropyltrimethoxysilane, N-isopropyl-3-aminopropyltrimethoxysilane, and N-isobutyl-3-aminopropyltrimethoxysilane. The optional difunctional amine (b1.2) may have the structure NR¹R², where each of R¹ and R² is independently an aliphatic, cycloaliphatic, or aromatic group.

Components (b1.1) and (b1.2) may be reacted in the presence of a solvent, including, without limitation, acetone, methyl ethyl ketone, methyl amyl ketone, n-butyl acetate, t-butyl acetate, propylene glycol monomethyl ether acetate, butyl propionate, toluene, xylenes, benzene, tetrahydrofuran, diethyl ether, methyl t-butyl ether, ethyl ethoxy propionate, N-methyl pyrrolidone, N-ethyl pyrrolidone, cyrene, and mixtures thereof.

The at least one alkoxy silane functional polyurea resin (b1) that may be used in the invention include those disclosed in U.S. Pat. No. 8,133,964, the disclosure of which is incorporated herein by reference. Preferably, the at least one alkoxy silane functional polyurea resin (b1) is a trimethoxysilane-terminated N-butyl urea resin, such as, for example, 1,1′,1″-(6,6′,6″-(2,4,6-trioxo-1,3,5-triazinane-1,3,5-triyl)tris(hexane-6,1-diyl))tris(3-butyl-3-(trimethoxysilyl) propyl) urea).

The at least one silicone resin (b2) may be the same or different as the at least one silicone resin (a3).

The at least one alkoxy silane functional polyurea resin (b1) may be present in the polyurea-siloxane resin composition in an amount ranging from about 40-95 wt. % (e.g., 45-90 wt. %, 50-85 wt. %, 55-80 wt. %, 60-75 wt. %, 65-70 wt. %), preferably about 84 wt. %, based on the total weight of the polyurea-siloxane resin composition. The at least one silicone resin (b2) may be present in the polyurea-siloxane resin composition in an amount ranging from about 5-60 wt. % (e.g., 10-55 wt. %, 15-50 wt. %, 20-45 wt. %, 25-40 wt. %, 30-35 wt. %), preferably about 16 wt. %, based on the total weight of the polyurea-siloxane resin composition.

The siloxane-modified resin composition (a) may be present in the curable coating composition in an amount ranging from about 40-99.9 wt. % (e.g., 45-99 wt. %, 50-95 wt. %, 55-90 wt. %, 60-85 wt. %, 65-80 wt. %, 70-75 wt. %), based on the total weight of the curable coating composition.

The at least one silicone oil additive (b) may be selected from a siloxane copolymer, a siloxane homopolymer, and mixtures thereof. For example, the siloxane copolymer may be selected from poly(dimethyl siloxane) (PDMS), poly(diphenyl siloxane) (PDPS), poly(phenyl-methyl siloxane) (PPMS), copolymers poly(diphenyl-dimethyl siloxane) and poly(phenylmethyl-dimethyl siloxane), and mixtures thereof. The poly(diphenylsiloxane-dimethylsiloxane) of the invention may be selected from, without limitation, 4-6 wt. % diphenyl content (3,500-4,000 g/mol⁻¹) and 18-22 wt. % diphenyl content (1,600-2,400 g/mol⁻¹). The poly(phenylmethyl-dimethyl siloxane) based siloxane copolymer of the invention may be selected from, without limitation, 8-12 wt. % phenylmethyl content (1,500-1,600 g/mol⁻¹), 48-52 wt. % phenylmethyl content (2,200 g/mol⁻¹), and 45-55 wt. % phenylmethyl content (600-800 g/mol⁻¹). The siloxane homopolymer of the invention may be selected from, without limitation, a poly(phenylmethylsiloxane) and a poly(dimethylsiloxane). The phenylmethylsiloxane of the invention may be selected from, without limitation, phenylmethylsiloxane (e.g., 2,500-20,000 g/mol⁻¹, 2,500-2,700 g/mol⁻¹). The dimethylsiloxane of the invention may be selected from, without limitation, dimethylsiloxane (1,000-20,000 g/mol⁻¹).

Preferably, the at least one silicone oil additive (b) is selected from poly(phenylmethylsiloxane-dimethylsiloxane), poly(dimethylsiloxane), and mixtures thereof. More preferably, the at least one silicone oil additive (b) is poly(phenylmethylsiloxane-dimethylsiloxane) (e.g., 8-12 wt. % poly(phenylmethylsiloxane-dimethylsiloxane) (1,500-1,600 g/mol⁻¹)), poly(dimethylsiloxane) (e.g., poly(dimethylsiloxane) (1,000-20,000 g/mol⁻¹)), and mixtures thereof.

The silicone oil additive (b) may be present in the curable coating composition in an amount ranging from about 0.01-60 wt. % (e.g., 0.05-55 wt. %, 0.1-50 wt. %, 0.5-45 wt. %, 1-40 wt. %, 2-35 wt. %, 3-30 wt. %, 4-25 wt. %, 5-20 wt. %, 6-15 wt. %, 7-10 wt. %, 8-9 wt. %), based on the total weight of the curable coating composition.

The optional at least one further additive (c) may be selected from a hardener additive, such as, for example, methyltrimethoxysilane, tetramethoxysilane, tetraethoxysilane, and mixtures thereof. Pigments and other additives known in the art to control coating rheology and surface properties may also be used as the further additive (c). Such coating additives include, but are not limited to, one or more leveling, rheology, and flow control agents such as silicones, fluorocarbons, or cellulosics; extenders; reactive coalescing aids such as those described in U.S. Pat. No. 5,349,026, the disclosure of which is incorporated herein by reference; plasticizers; flatting agents; pigment wetting and dispersing agents and surfactants; ultraviolet (UV) absorbers; UV light stabilizers; tinting pigments; colorants; defoaming and antifoaming agents; anti-settling, anti-sag and bodying agents; anti-skinning agents; anti-flooding and anti-floating agents; biocides, fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005. Further examples of such additives may be found in U.S. Pat. No. 5,371,148, the disclosure of which is incorporated herein by reference.

Examples of flatting agents that may be used as the further additive (c) include, but are not limited to, synthetic silica, available from the Davison Chemical Division of W. R. Grace & Company as SYLOID®; polypropylene, available from Hercules Inc., as HERCOFLAT®; synthetic silicate, available from J. M. Huber Corporation, as ZEOLEX®.

Examples of viscosity, suspension, and flow control agents that may be used as the further additive (c) include, but are not limited to, polyaminoamide phosphate, high molecular weight carboxylic acid salts of polyamine amides, and alkylene amine salts of an unsaturated fatty acid, all available from BYK Chemie U.S.A. as ANTI TERRA®. Further examples include, but are not limited to, polysiloxane copolymers, polyacrylate solution, cellulose esters, hydroxyethyl cellulose, hydroxypropyl cellulose, polyamide wax, polyolefin wax, hydroxypropyl methyl cellulose, polyethylene oxide, and the like.

Fillers may also be used as the further additive (c), including, but not limited to, calcium carbonate such as calcite, dolomite, talc, mica, feldspar, barium sulfate, kaolin, nephelin, silica, perlite, magnesium oxide, and quartz flour, etc. Fillers (and pigments) may also be added in the form of nanotubes or fibers, thus, apart from the before-mentioned examples of fillers, the further additive (c) may also comprise fibers, e.g., those generally and specifically described in WO 00/77102, the disclosure of which is incorporated herein by reference.

The further additive (c) may be present in the curable coating composition in an amount ranging from about 0.01-60 wt. % (e.g., 0.05-55 wt. %, 0.1-50 wt. %, 0.15-45 wt. %, 0.2-40 wt. %, 0.3-35 wt. %, 0.4-30 wt. %, 0.5-25 wt. %, 1-20 wt. %, 2-15 wt. %, 3-10 wt. %, 4-9 wt. %, 5-8 wt. %, 6-7 wt. %), based on the total weight of the curable coating composition.

The optional at least one catalyst (d) may be dibutyltin diacetate, dibutyl tin dilaurate, and the like. The catalyst (d) may be present in the curable coating composition in an amount ranging from about 0.01-10% (e.g., 0.1-9%, 0.2-8%, 0.3-7%, 0.4-6%, 0.5-5%, 0.6-4%, 0.7-3%, 0.8-2%, 0.9-1%), based on the total solids of the coating composition.

The optional at least one solvent (e) may be selected from hydrocarbon, ester, ketone, ether, ether-ester, alcohol, or ether-alcohol type solvents, either individually or in mixtures. Examples of solvents that can be added to the curable coating compositions of the invention include, but are not limited to benzene, toluene, xylene, aromatic 100, aromatic 150, acetone, methylethyl ketone, methyl amyl ketone, butyl acetate, t-butyl acetate, tetrahydrofuran, diethyl ether, ethyl-3-ethoxypropionate (EEP), isopropanol, butanol, butoxyethanol, and the like. The solvent (e) may be present in the curable coating composition in an amount ranging from about 0.1-90 wt. % (e.g., 0.5-50 wt. %, 1-40 wt. %, 2-35 wt. %, 3-30 wt. %, 4-25 wt. %, 5-20 wt. %, 6-15 wt. %, 7-10 wt. %, 8-9 wt. %), based on the total weight of the curable coating composition.

The invention also relates to a cured coating composition, comprising, consisting essentially of, or consisting of the curable coating composition of the invention. The curable coating composition of the invention may be cured at ambient conditions for 1-72 hours, for example.

The invention also relates to an article of manufacture, comprising, consisting essentially of, or consisting of:
a) a substrate; and
b) the curable coating composition of the invention applied on at least a part of the surface of the substrate.

The invention also relates to a method of coating a substrate comprising, consisting essentially of, or consisting of:
providing a substrate;
applying the curable coating composition of the invention on at least a part of the surface of the substrate to form a coated substrate; and
curing the coated substrate under conditions sufficient to cure the curable coating composition.

The substrate may also be coated with another coating (e.g., a primer) before application of the curable coating composition of the invention.

The term “applying” is used in its normal meaning within the paint industry. Thus, “applying” is conducted by any conventional means, e.g., by brush, by roller, by spraying (e.g., convention air-atomized spray, airless spray, HVLP), by dipping, by drawdown, etc. The commercially most interesting way of “applying” the curable coating composition of the invention is by spraying. Hence, the curable coating composition is preferably sprayable. Spraying is effected by means of conventional spraying equipment known to the person skilled in the art. The coating is typically applied in a dry film thickness of 20-600 μm (e.g., 30-500 μm, 40-400 μm, 50-300 μm, 75-200 μm, 100-150 μm).

The term “at least a part of the surface of a substrate” refers to the fact that the curable coating composition of the invention may be applied to any fraction of the surface (or, for that matter, the entire surface). For many applications, the curable coating composition is at least applied to the part of the substrate where the surface may contact the atmosphere.

The term “substrate” means a solid material onto which the curable coating composition is applied. The substrate typically comprises a metal such as steel, iron, aluminum, or glass- or carbon-fiber composite, but also includes wood, plastic, and glass. The substrate may be a metal substrate, in particular, a steel substrate. The substrate may also be a glass-fiber reinforced polyester substrate.

The term “surface” is used in its normal sense, and refers to the exterior boundary of an object.

The surface of the substrate may be the “native” surface (e.g., the steel surface).

### Exemplary Embodiments of the Invention

E1) A curable coating composition comprising, consisting essentially of, or consisting of:
a) at least one siloxane-modified resin composition;
b) at least one silicone oil additive;
c) optionally, at least one further additive;
d) optionally, at least one catalyst; and
e) optionally, at least one solvent.

E2) The curable coating composition of E1, wherein the siloxane-modified resin composition is selected from an epoxy-siloxane resin composition, polyurea-siloxane resin composition, and mixtures thereof.

E3) The curable coating composition of E2, wherein the epoxy-siloxane resin composition comprises, consists essentially of, or consists of the reaction product of:
a1) at least one epoxy resin;
a2) at least one silane compound; and
a3) at least one silicone resin.

E4) The curable coating composition of E3), wherein the at least one epoxy resin (a1) is selected from bisphenol-A epoxy resin, glycidyl ethers of bisphenol-A, bisphenol-F, tetramethyl bisphenol-A, tetramethyl bisphenol-F, hydrogenated bisphenol-A, phenolic resin, butane diol, hexane diol, cyclohexane dimethanol, trimethylolpropane, and mixtures thereof.

E5) The curable coating composition of E3 or E4, wherein the at least one epoxy resin (a1) is a bisphenol-A epoxy resin.

E6) The curable coating composition of E5, wherein the at least one bisphenol-A epoxy resin has a viscosity at 25° C. ranging from about 1800-2500 cps.

E7) The curable coating composition of any one of E4-E6, wherein the at least one bisphenol-A epoxy resin may be hydrogenated.

E8) The curable coating composition of any one of E3-E7, where the at least one silane compound (a2) is selected from (3-aminopropyl)trimethoxysilane, methyltrimethoxysilane, and N-butylaminopropyltrimethoxysilane.

E9) The curable coating composition of any one of E3-E8, wherein the at least one silicone resin (a3) is a methoxy-functional silicone resin.

E10) The curable coating composition of E9, wherein the methoxy-functional silicone resin has a viscosity at 25° C. of about 90-180 sCt and a molecular weight average ranging between 900-1900 Daltons.

E11) The curable coating composition of E2, wherein the polyurea-siloxane resin composition comprises, consists essentially of, or consists of:
b1) at least one alkoxy silane functional polyurea resin; and
b2) at least one silicone resin.

E12) The curable coating composition of E11, wherein the polyurea resin comprises, consists essentially of, or consists of the reaction product of:
b1.1) at least one polyisocyanate resin; and
b1.2) at least one amino-functional alkoxy silane and, optionally, at least one difunctional amine, wherein the components (b1.1) and (b1.2) are reacted under conditions sufficient to form the alkoxy silane functional polyurea resin.

E13) The curable coating composition of E12, wherein the at least one amino-functional alkoxy silane is be substituted at the at the N-position with a group selected from C3-C6 alkyl, cyclohexyl, and phenyl.

E14) The curable coating composition of E13, wherein the at least one amino-functional alkoxy silane is selected from the group consisting of N-butyl-3-aminopropyltrimethoxysilane, N-butyl-3-aminopropylmethyldimethoxysilane, N-butyl-3-aminopropyltriethoxysilane, N-ethyl-3-aminopropyltriethoxysilane, N-cyclohexyl-3-aminopropyltrimethoxysilane, N-phenyl-3-aminopropyltrimethoxysilane, N-hexyl-3-aminopropyltrimethoxysilane, N-pentyl-3-aminopropyltrimethoxysilane, N-isopropyl-3-aminopropyltrimethoxysilane, and N-isobutyl-3-aminopropyltrimethoxysilane.

E15) The curable coating composition of any one of E12-E14, wherein the optional difunctional amine may have the structure NR¹R², where each of R¹ and R² is independently an aliphatic, cycloaliphatic, or aromatic group.

E16) The curable coating composition of any one of E12-E15, wherein components (b1.1) and (b1.2) are reacted in the presence of a solvent.

E17) The curable coating composition of E16, wherein the solvent is selected from acetone, methyl ethyl ketone, methyl amyl ketone, n-butyl acetate, t-butyl acetate, propylene glycol monomethyl ether acetate, butyl propionate, toluene, xylenes, benzene, tetrahydrofuran, diethyl ether, methyl t-butyl ether, ethyl ethoxy propionate, N-methyl pyrrolidone, N-ethyl pyrrolidone, cyrene, and mixtures thereof.

E18) The curable coating composition of E11, wherein the at least one alkoxy silane functional polyurea resin (b1) is a trimethoxysilane-terminated N-butyl urea resin.

E19) The curable coating composition of E18, wherein the at least one alkoxy silane function polyurea resin is 1,1′,1″-(6,6′,6″-(2,4,6-trioxo-1,3,5-triazinane-1,3,5-triyl)tris(hexane-6,1-diyl))tris(3-butyl-3-(trimethoxysilyl) propyl) urea).

E20) The curable coating composition of E11, wherein the at least one silicone resin (b2) may be the same or different as the at least one silicone resin (a3).

E21) The curable coating composition of E11, wherein the at least one silicone resin (b2) is a methoxy-functional silicone resin.

E22) The curable coating composition of E21, wherein the methoxy-functional silicone resin has a viscosity at 25° C. of about 90-180 sCt and a molecular weight average ranging between 900-1900 Daltons.

E23) The curable coating composition of any one of E1-E22, wherein the at least one siloxane-modified resin composition (a) is present in the coating composition in an amount ranging from about 40-99.9 wt. %, based upon the total weight of the coating composition.

E24) The curable coating composition of any one of E1-E23, wherein the at least one silicone oil additive (b) is selected from a siloxane copolymer, a siloxane homopolymer, and mixtures thereof.

E25) The curable coating composition of E24, wherein the siloxane copolymer is selected from poly(dimethyl siloxane) (PDMS), poly(diphenyl siloxane) (PDPS), poly(phenyl-methyl siloxane) (PPMS), copolymers poly(diphenyl-dimethyl siloxane) and poly(phenylmethyl-dimethyl siloxane), and mixtures thereof.

E26) The curable coating composition of E25, wherein the poly(diphenylsiloxane-dimethylsiloxane) is selected from 4-6 wt. % diphenyl content (3,500-4,000 g/mol⁻¹), 18-22 wt. % diphenyl content (1,600-2,400 g/mol⁻¹), and mixtures thereof.

E27) The curable coating composition of E25 or E26, wherein the poly(phenylmethyl-dimethylsiloxane) is selected from 8-12 wt. % phenylmethyl content (1,500-1,600 g/mol⁻¹), 48-52 wt. % phenylmethyl content (2,200 g/mol⁻¹), 45-55 wt. % phenylmethyl content (600-800 g/mol⁻¹), and mixtures thereof.

E28) The curable coating composition of any one of E24-E27, wherein the siloxane homopolymer is selected from a poly(phenylmethylsiloxane), a poly(dimethylsiloxane), and mixtures thereof.

E29) The curable coating composition of E28, wherein the poly(phenylmethylsiloxane) is selected from phenylmethylsiloxane (2,500-20,000 g/mol⁻¹).

E30) The curable coating composition of E28 or E29, wherein the poly(dimethylsiloxane) is selected from dimethylsiloxane (1,000-20,000 g/mol⁻¹).

E31) The curable coating composition of E15, wherein the at least one silicone oil additive (b) is selected from poly(phenylmethylsiloxane-dimethylsiloxane), poly(dimethylsiloxane), and mixtures thereof.

E32) The curable coating composition of E31, wherein the at least one silicone oil additive (b) is selected from poly(phenylmethylsiloxane-dimethylsiloxane) (e.g., 8-12 wt. % poly(phenylmethylsiloxane-dimethylsiloxane) (1,500-1,600 g/mol⁻¹)), poly(dimethylsiloxane) (e.g., poly(dimethylsiloxane) (1,000-20,000 g/mol⁻¹)), and mixtures thereof.

E33) The curable coating composition of any one of E1-E32, wherein the silicone oil additive (b) is present in the coating composition in an amount ranging from about 0.01-60 wt. %, based upon the total weight of the coating composition.

E34) The curable coating composition of any one of E1-E33, wherein the at least one further additive (c) is a hardener additive.

E35) The curable coating composition of E34, wherein the hardener additive is selected from methyltrimethoxysilane, tetramethoxysilane, tetraethoxysilane, and mixtures thereof.

E36) The curable coating composition of any one of E1-E35, wherein the at least one catalyst (d) is selected from dibutyltin diacetate, dibutyl tin dilaurate, and mixtures thereof.

E37) The curable coating composition of any one of E1-E36, wherein the at least one catalyst (d) is present in the coating composition in an amount ranging from about 0.01-10%, based upon the total solid contents of the coating composition.

E38) The curable coating composition of any one of E1-E37, wherein the at least one solvent (e) is selected from hydrocarbon, ester, ketone, ether, ether-ester, alcohol, or ether-alcohol type solvents, and mixtures thereof.

E39) The curable coating composition of any one of E1-E38, wherein the at least one solvent (e) is selected from benzene, toluene, xylene, aromatic 100, aromatic 150, acetone, methylethyl ketone, methyl amyl ketone, butyl acetate, t-butyl acetate, tetrahydrofuran, diethyl ether, ethyl-3-ethoxypropionate (EEP), isopropanol, butanol, butoxyethanol, and mixtures thereof.

E40) The curable coating composition of any one of E1-E39, wherein the at least one solvent (e) is present in the coating composition in an amount ranging from about 0.01-90 wt. %, based upon the total weight of the coating composition.

E41) A cured coating composition, comprising the curable coating composition of any one of E1-E40.

E42) An article of manufacture, comprising:
a) a substrate; and
b) the curable coating composition of any one of E1-E40 applied on at least a part of the surface of the substrate.

E43) The article of manufacture of E42, where the substrate is steel.

E44) A method of coating a substrate comprising:
providing a substrate;
applying the curable coating composition of any one of E1-E40 on at least a part of the surface of the substrate to form a coated substrate; and
curing the coated substrate under conditions sufficient to cure the curable coating composition.

E45) The method of E44, wherein the coated substrate is cured at ambient conditions.

E46) The method of E44 or E45, wherein the coated substrate is cured for about 1-72 hours.

E47) The method of any one of E44-E46, wherein the substrate is steel.

E48) The method of any one of E44-E47, wherein the substrate is coated with another coating before application of the curable coating composition.

### EXAMPLES

### Example 1: Silicone Oil Modified Epoxy-Siloxane Coatings

### 1.1 Materials

Eponex 1510 was purchased from Hexion (OH, USA). DC-3074 was purchased from Dow Chemical Company (MI, USA). The (3-aminopropyl) trimethoxysilane, 97% was purchased from Sigma Aldrich (MO, USA). The t-butyl acetate was purchased from Alfa Aesar (MA, USA). Methytrimethoxysilane, 99% and PDMS copolymer and homopolymer oils, 4-6 wt. % diphenylsiloxane-dimethylsiloxane (3,500-4,000 g mol⁻¹), 18-22 wt. % diphenylsiloxane-dimethylsiloxane (1,600-2,400 g mol⁻¹), 8-12 wt. % phenylmethylsiloxane-dimethylsiloxane (1,500-1,600 g mol⁻¹), 48-52 wt. % phenylmethylsiloxane-dimethylsiloxane (2,200 g mol⁻¹), 45-55 wt. % phenylmethylsiloxane-diphenylsiloxane (600-800 g mol⁻¹), phenylmethylsiloxane (2,500-2,700 g mol⁻¹) were purchased from Gelest Inc (PA, USA). All materials were used as provided without any further purification. Intergard 264, Intersleek® 700, Intersleek® 900, and Intersleek® 1100SR were purchased from AkzoNobel, International Paint LLC (TN, USA). Silastic® T2 silicone elastomer was purchased from Dow Corning (MI, USA). Steel and aluminum substrates used were QD-48, QD-36, and A-48 purchased from Q-Lab (OH, USA). The aluminum panels (A-48) were sandblasted and then primed, using spray application, with Intergard 264 marine epoxy primer. Falcon sterile, bacterial grade 24-multiwell plates were purchased from VWR International (PA, USA).

### 1.2 Preparation of Epoxy Resin Component

The epoxy resin was made from a hydrogenated bisphenol-a epoxy resin, a methyltrimethoxysilane, and a polysiloxane. The amounts of each are listed below in Table 1. These components were mixed using a magnetic stir bar for 1 hour. The epoxide equivalent weight (EEW) of the prepared epoxy resin was determined based on ASTM D 1652. EEW titrations were done to determine the EEW of the epoxy resin to control stoichiometric EEW: amine hydrogen equivalent weight (AHEW) ratios for formulation of the coatings. The AHEW was obtained from the supplier. First, a crystal violet indicator and a 0.1M HBr in glacial acetic acid were prepared. The HBr solution was then standardized by titration of dried potassium acid phthalate (204.2 g/mol) and four drops of crystal violet indicator. The normality (N) was then determined using the following equation:

$$N = \frac{1000 \times W}{204.2 \times V}$$

W=weight of potassium acid phthalate (g)
V=volume of HBr solution (mL)

Next, 1-2 g of epoxy resin and four drops of indicator were dissolved in chloroform then the normalized HBr solution was used to titrate the epoxy resin and a blank that contained the same amount of chloroform and indicator. Three titrations were conducted and then calculations were done to determine the EEW of the resin using the following equation:

$$EEW = \frac{1000 \times W}{N \times ( V - B )}$$

W=sample mass (g)
N=normality of HBr solution
V=volume of HBr for titration (mL)
B=volume of HBr for blank (mL)

### 1.3 Coating Formulations

The base coating was prepared based on a formulation disclosed in U.S. Pat. No. 5,618,860, the disclosure of which is incorporated herein by reference. The epoxy resin was mixed with (3-aminopropyl) trimethoxysilane at a 1:1 EEW:AHEW along with adding t-butyl acetate to improve flow Table 2. The base coating was modified by adding various non-reactive siloxane copolymer and homopolymer oils to improve the surface properties. These siloxane oils were added in different amounts based on the percent weight of the epoxy resin.

TABLE 1
Epoxy resin components

| Epoxy resin | Parts |
|---|---|
| Eponex 1510 | 45.72 |
| Gelest Methyltrimethoxysilane | 2.97 |
| DOWSIL DC-3074 | 51.31 |

TABLE 2
Coating formulation amounts and ratios

| Component | Amounts g |
|---|---|
| Epoxy Resin | 10.0 |
| (3-aminopropyl) trimethoxysilane | 2.008 |
| t-butyl acetate | 0.726 |

| Siloxane Oil | 5% | 10% |
|---|---|---|
| Various oils used | 0.5 | 1.0 |

Next, a variety of siloxane copolymer oils at different amounts were incorporated into the coating to observe the differences that the amount of phenyl or methyl content would have on the surface properties of each formulation. The formulation ID and description of each oil composition are in Table 3. The formulations with “s” had 50% more solvent (^{˜}1.0 g) than the regular formulations. Besides the “s” formulations, the only difference between the formulations were the type and amount of silicone oil added.

TABLE 3
Coating formulations and oil composition

| Formulation | Siloxane Oil Composition |
|---|---|
| Base | No oil additive |
| 5% DPDM-005 | (4-6 wt. % Diphenylsiloxane)- |
| 10% DPDM-005 | (Dimethylsiloxane) |
| 5% DPDM-020 | (18-22 wt. % Diphenylsiloxane)- |
| 10% DPDM-020 | (Dimethylsiloxane) |
| 5% PMDM-010 | (8-12 wt. % Phenylmethylsiloxane)- |
| 5% PMDM-010s | (Dimethylsiloxane) |
| 10% PMDM-010 | |
| 10% PMDM-010s | |
| 5% PMDM-050 | (48-52 wt. % Phenylmethylsiloxane)- |
| 10% PMDM-050 | (Dimethylsiloxane) |
| 5% PMDP-050 | (45-55 wt. % Phenylmethylsiloxane)- |
| 10% PMDP-050 | (Diphenylsiloxane) |
| 10% PM-100 | Phenylmethysiloxane |
| 5% DM-100 | Dimethylsiloxane |

For each formulation, the resin, solvent, hardener, and oil additive were mixed using a magnetic stir plate for 30 minutes before leaving open for 10 minutes to allow off-gassing of the solvent and any bubbles created by the mixing. Application was done on smooth finish steel Q-panels using a BYK drawn down bar at 4 and 8 mil wet film thickness. The panels were cleaned using hexane and then isopropanol prior to application of each formulation. After the panels were coated, the panels were then left on the lab bench at ambient conditions to cure. Coatings were tack-free after one hour, dry through after one day, and fully cured after three days.

### 1.4 Attenuated Total Reflection Fourier Transform Infrared Spectroscopy

ATR-FTIR was used to characterize the coatings. A Thermo Scientific Nicolet 8700 FT-IR instrument (MA, USA) with Smart iTR™ accessory was used to collect all the spectra in the 4000-400 cm⁻¹ range.

### 1.5 Surface Characterization

Water contact angle (WCA) and surface free energy (SFE) were determined using a Kruss® DSA100 drop-shape analyzer (Kruss, Germany). Coatings were placed on the stage with no tilt. For each sample, five measurements were done where 2 μl of water and methyl diiodide (MDI) were dropped onto the sample using a dual-dosing attachment. After the droplets settled, the WCA and MDI measurements were taken and using the Advance™ software, the SFE was determined by the Owens-Wendt calculation.

### 1.6 Ice Adhesion

The procedure for the ice adhesion measurements has been previously published. Ice adhesion measurements were done at −10° C. using a Peltier-plate system. Pieces of ice (1 cm×1 cm×0.6 cm) were frozen onto the coated substrate and removed using a Nextech DFS500 force gauge at a velocity of 74 μm/s. For critical length measurements, a larger Peltier-plate was used. A Laird Technologies Peltier-plate with a length of 22 cm and width of 6 cm was used. For these tests, the length of ice was varied from 1 cm to 20 cm while the width and height remained at 1 cm and 0.6 cm respectively. Five measurements were taken for each length of ice.

### 1.7 Biological Assays

Microorganism fouling assays were conducted on eleven sample coatings and five commercial coatings to use as a baseline. Barnacle assays were conducted on nine sample coatings and one commercial coating. Coatings were prepared on aluminum panels that were sandblasted and primed using Intergard 264. 15 mm disks were punched out of the panels and then glued into the base of the Falcon 24-multiwell plates. All wells and panels were pre-leached for 28 days with tap water recirculating every 4 hours. After the 28 days the biological assays were conducted.

1.7.1 Cell Attachment and Removal of Diatom (N. incerta)

First, leachate toxicity screening was conducted by immersing the well plates in recirculating water for 7 days. After this time, the plates were incubated for 24 hours in 1.0 ml of Guillard's F/2 growth medium. The extracts were collected, and 1 ml was mixed with 0.05 ml of Navicula incerta (N. incerta) along with growth medium. A 0.150 ml aliquot of this solution was transferred to a 96-well plate incubated for 48 hours at 18° C. with a 16:8 light:dark cycle. After the incubation, the N. incerta biomass was measured by the fluorescence intensity of chlorophyll a and recorded in relative fluorescence units (RFU). A positive growth control containing nutrient medium, and a negative growth control made from 6 μm of triclosan were used to compare relative toxicity. For biofilm growth, a suspension of N. incerta diatoms (^{˜}10⁵ cells/mL) was diluted to an OD of 0.03 at absorbance 660 nm in artificial seawater (ASW) containing Guillard's F/2 medium. 1 mL of the ASW containing N. incerta was added to each well and then incubated for 48 hours at 18° C. with a 16:8 light:dark cycle. After incubation, the biomass was extracted using 1 ml of dimethyl sulfoxide, and 0.150 ml of the extracts were again measured for chlorophyll a fluorescence and recorded as RFU. The N. incerta was given 2 hours to settle on the surface and then water jet removal was done. With three columns for each sample, the first column was not water-jetted. The second column was water-jetted for 10 seconds at 10 psi. The third column was water-jetted at 20 psi. The water jet removal was reported in RFU as biomass remaining, which was measured using chlorophyll a fluorescence, and 1-way ANOVA statistical analysis was used to determine the adhesion results.

1.7.2 Biofilm Growth and Removal of Bacteria (C. lytica)

To test the toxicity, the samples were placed in recirculating water for 7 days. After that, they were incubated in 1 ml of biofilm growth medium (BGM) for 24 hours. The extracts from this were then mixed with 0.05 ml of Cellulophaga lytica (C. lytica) (^{˜}10⁸ cells/mL) and suspended in BGM. A 0.150 ml aliquot of this mixture was then transferred to a 96-well plate and incubated for 24 hours at 28° C. The growth was measured by adding 0.5 ml of 0.35% crystal violet solution. After fifteen minutes, each well was rinsed three times with DI water. Then the crystal violet biofilm was extracted using 0.5 mL of 33% glacial acetic acid. A 0.15 mL aliquot of this extract was transferred to a 96-well plated. Absorbance was measured at 600 nm using a multi-well plate spectrophotometer. A BGM positive growth control and negative growth control (15 μg/ml of triclosan in BGM) were included for reference. For biofilm growth, C. lytica was rinsed with 1 ml of ASW and suspended with BGM to a density of ^{˜}10⁷ cells/ml. Then 1 ml of that solution was added to each well and incubated for 24 hours at 28° C. The plates were tested with the water jet the same as the N. incerta except for spray time, which was 5 seconds. Biofilm remaining was determined by ATP bioluminescence and was reported as fluorescence intensity. The same statistical analysis was done to determine the adhesion results.

1.7.3 Attachment and Removal of Barnacles (A. amphitrite)

For each sample coating, six adult Amphibalanus amphitrites (barnacles) were removed from a glass panel which was coated with Silastic-T2 and then immobilized on the surface of the sample coating using a custom template. The barnacles were fed with brine shrimp and left to grow for 2 weeks. After this, the barnacles were removed using a handheld force gauge which measures the peak force to detach the barnacle from the surface. After removal, the basal plate area was determined using Sigma Scan Pro 5.0. Barnacle adhesion strength (MPa) was calculated by dividing the force to remove the barnacle by the respective basal plate area. Barnacles that required no force for removal were considered to have not attached to the surface and were recorded as such.

### 1.8 Results and Discussion

One of the main approaches to lower ice adhesion is to modify the surface properties by making the surface hydrophobic. This can be done by utilizing additives or changing surface roughness to obtain a micro/macrostructure. Epoxy-siloxane coatings are a current system used as the topcoats for ship hulls and superstructure. These epoxy-siloxane coatings exhibit high strength and good weatherability, especially UV protection. The present invention modified the epoxy-siloxane system to improve the surface properties. To do this, various siloxane copolymer and homopolymer oils were integrated into an epoxy-siloxane network to determine the effects of the hydrophobicity of the surface regarding the ice-releasing properties. The anti-fouling/fouling release (AF/FR) properties of the coatings were also studied. A base epoxy-siloxane was made based on a published procedure. Once the base coating was successfully made, it was modified with the silicone oils.

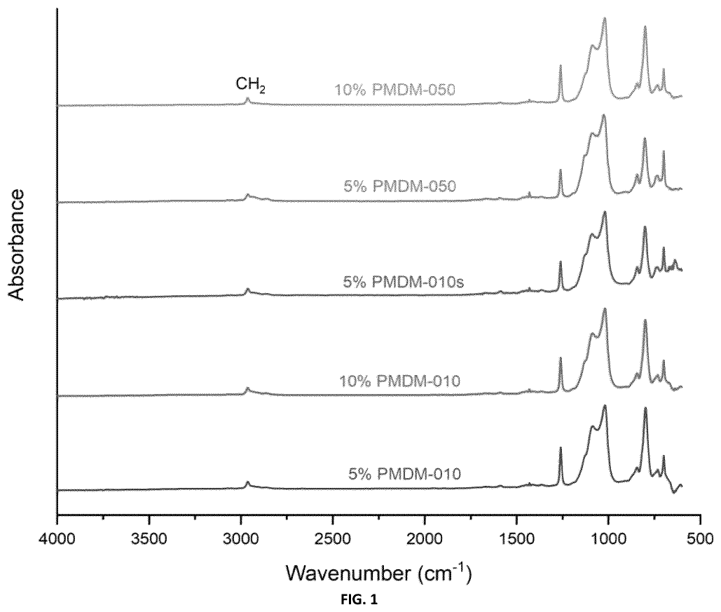

ATR-FTIR was used to characterize the coatings to measure any difference of surface chemistry seen between the various oil compositions used. As seen in FIG. 1, no significant difference was seen between the coatings. This was not an unexpected result as the oils are added in such a small amount.

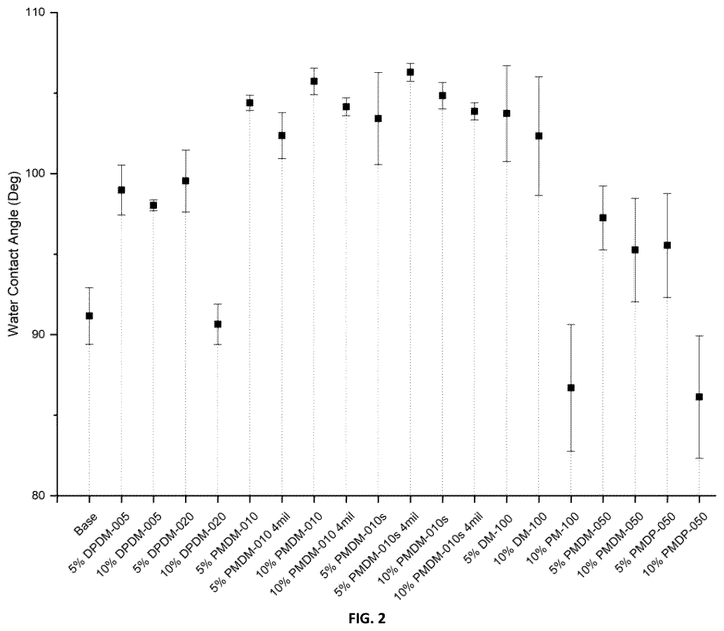

The effects of the oil additives were first measured by determining the static water contact angle (WCA). Measurements of the base coating were also done to act as a control. All the measurements were done on a level stage. Five measurements were taken on each coating across the entire length of the panel. In general, the coatings with methyl-dominant oil had a higher contact angle and the coatings with phenyl-dominant oil had a lower contact angle (FIG. 2). As the concentration of oil was increased in the coatings this trend became more apparent. As seen in FIG. 2, the methyl-dominant oils had a higher contact angle at 10% vs 5%. Oppositely, the phenyl-dominant oils had a lower contact angle at 10% vs 5%. Esumi et al. (“The Effect of Ultraviolet Radiation on the Wettability of Silicone Polymers,” Bulletin of the Chemical Society of Japan 1982, 55 (9), 3019-3020) reported a polydiphenylsiloxane coating with a surface energy of 46.5 mN/m. The coatings with a higher percentage of PDMS yielded a higher contact angle. This makes sense due to the hydrophobicity of PDMS.

The samples that consistently showed a high contact angle were the PMDM-010 coatings. In all the coatings containing PMDM-010, the contact angle was over 100° regardless of coating thickness, oil concentration, or solvent concentration. In addition to the PMDM-010 coating's high contact angle, these coatings produced the best films. While the DM-100 coatings, which are pure PDMS, had a similar contact angle to the PMDM-010 coatings, the films produced were uneven and rough. On the other hand, the PMDM-050, PMDP-050, and PM-100 coatings yielded a low contact angle slightly above the base coating. The 10% PMDP-050 and 10% PM-100 formulations, containing oils with high phenyl content, had a contact angle significantly lower than the base. This result further indicates the hydrophilic effect that the phenyl dominant oils have on the surface properties of this system.

An unexpected result was the higher contact angle seen in the “s” formulations. In nearly all samples with additional solvent, the “s” coating had a higher contact angle compared to its counterpart. Initially, the extra solvent was added to improve flow and create a more uniform film, but the results indicate that this extra solvent is affecting the surface properties in some way. One thought for this is the extra solvent creates more mobility in the system, which allows more silicone oil to get to the surface before the coating cures.

Ice adhesion measurements were done by pushing a 1 cm² block of ice off the sample and recording the force required to break the ice free. Further measurements including critical length, critical force, and interfacial toughness were determined by freezing pieces of ice of different lengths onto the coatings and recording the force required to detach the ice. The latter approach provided a test more comparable to real-world scenarios. When ice accretion occurs on aircrafts, wind turbine blades, or ships it forms in large sheets. Understanding how large pieces of ice detach from a surface is important with the aim of designing materials specifically for the easy removal of large pieces of ice. Ice adhesion measurements were conducted on several of the coatings specifically chosen to monitor potential trends. Coating thickness, solvent concentration, oil concentration, and oil composition were varied, and ice adhesion was measured to see the effects of these changes on the surface properties of the epoxy-siloxane base coating.

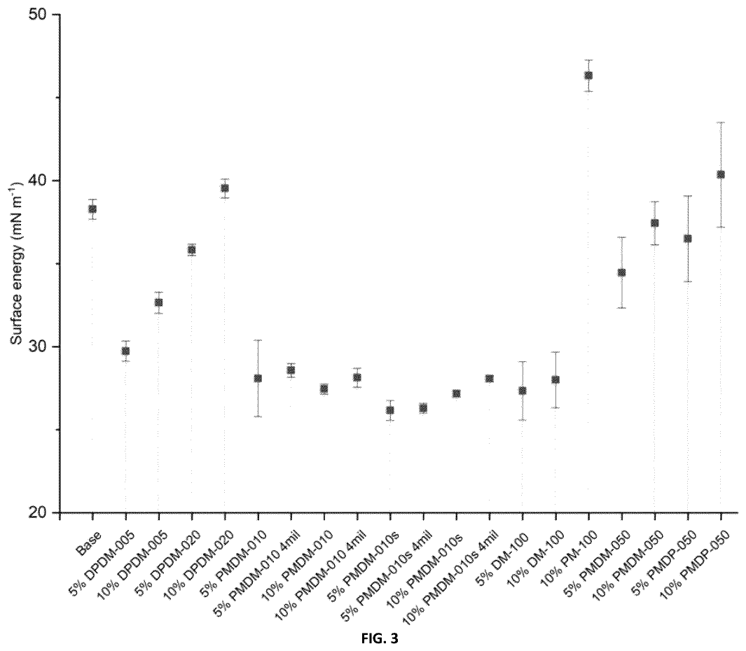

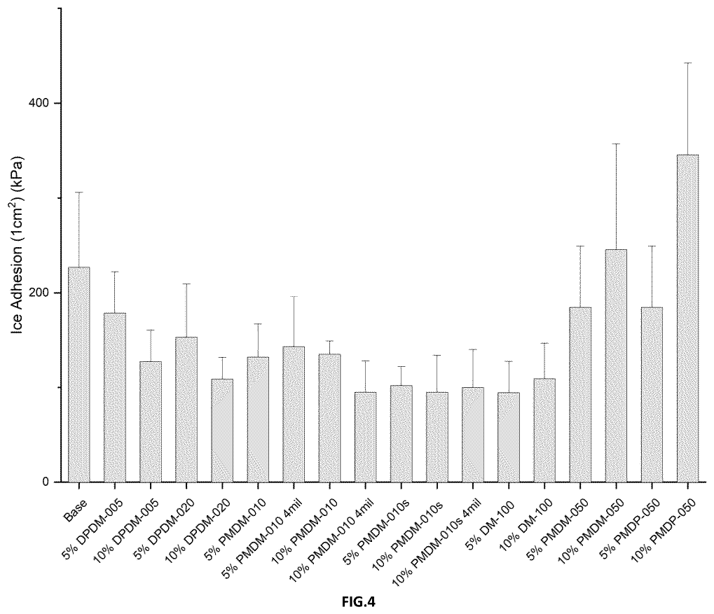

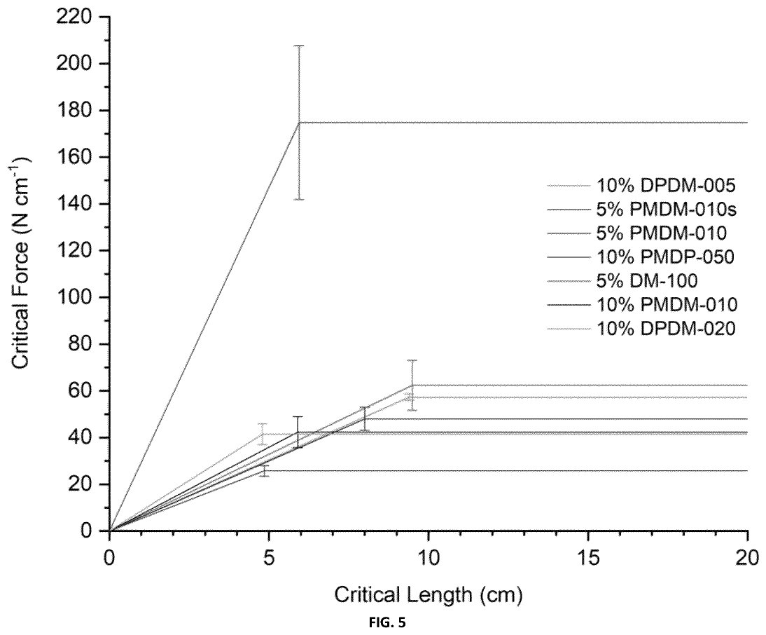

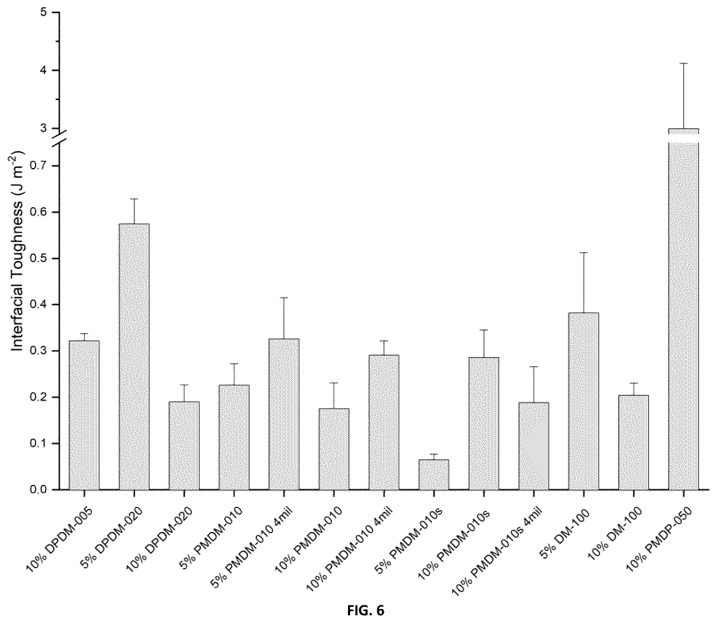

The trends seen in the contact angle measurements seem to correlate to the ice adhesion results well. The composition of the oil additive had significant influence on the ice adhesion (FIG. 4) results as it did in the contact angle (FIG. 2) and surface energy measurements (FIG. 3). The coatings with methyl dominant oil additive required lower force to detach the ice than the coatings with phenyl dominant oils. Some of the coatings with phenyl dominant oils required much more force to remove the ice than the base coating. Both PMDM-050 and PMDP-050 had a higher ice adhesion than the base coating. The 10% PMDP-050 had the highest ice adhesion at a level much higher than the base coating. Regarding film thickness, there does not seem to be a noticeable difference in ice adhesion between similar coatings having different film thicknesses. Some formulations showed higher ice adhesion with a thicker film, and some showed the opposite. Changes in the amount of solvent had significant impacts on the results, specifically for the PMDM-010 coatings. This was highlighted in the critical length (FIG. 5) and interfacial toughness results (FIG. 6). For smaller pieces of ice, adhesion strength was dependent on the area of the coating/ice interface. As the area of this interface increased, the shear stress required to detach it continued to increase. Critical length is the point at which the shear stress is no longer dependent on the area of the interface. At the critical length, the force required to remove a piece of ice plateaus and remains constant. This force is considered the critical force.

Initial ice adhesion results (1 cm²) showed similar trends to what was seen in the contact angle and surface energy data. The coatings with methyl-dominant oil additives performed better than the coatings with phenyl-dominant oils, but little difference were seen between the different coatings with methyl-dominant oils. As shown in FIG. 4, the 10% DPDM-005 and 10% DPDM-020 had a similar low ice adhesion when compared to the 5% PMDM-010s, but when larger pieces of ice were tested the 5% PMDM-010s had the lowest critical force and length out of every other coating (FIG. 5). The 5% PMDM-010s reached its critical length at approximately 4.85 inches and required the least amount of force to remove long pieces of ice. The 10% DPDM-005 had a similar critical length as the 5% PMDM-010s but required nearly twice the force to remove the ice. An interesting result is the large difference between the 5% PMDM-010 and the 5% PMDM-010s, the only difference between these coatings being more solvent added in the formulation. The critical length of the 5% PMDM-010 is nearly twice the critical length and critical force of the 5% PMDM-010s. Additionally, both the 5% PMDM-010 and 5% PMDM-010s had lower critical length and critical force than the 5% DM-100, which had the highest critical length. This would indicate that the incorporation of some phenyl content into the coating is beneficial to the surface properties of the coatings and may be preferable to pure PDMS. The phenyl-dominant 10% PMDP-050 had a slightly higher critical length than the 5% PMDM-010s but a significantly higher critical force than every other coating.

The interfacial toughness is calculated using critical force. Interfacial toughness is the resistance an interface has to crack propagation. For large-scale deicing, a low interfacial toughness is desirable. This indicates that the force required to remove a large piece of ice is low. The coatings with phenyl-dominant oils had higher interfacial toughness than the coatings with methyl-dominant oils (FIG. 6). The 10% PMDP-050 had an interfacial toughness tenfold of the other coatings tested. The 5% PMDM-010s on the other hand, had an interfacial toughness of 0.06 J/m², which is lower than the interfacial toughness due to Van der Waals forces (0.1 J/m²). This result is quite significant, even more so when considering the difference in interfacial toughness seen between the 5% PMDM-010s and the 5% PMDM-010. The additional solvent lowered the interfacial toughness of the coating from 0.23 to 0.06 J/m².

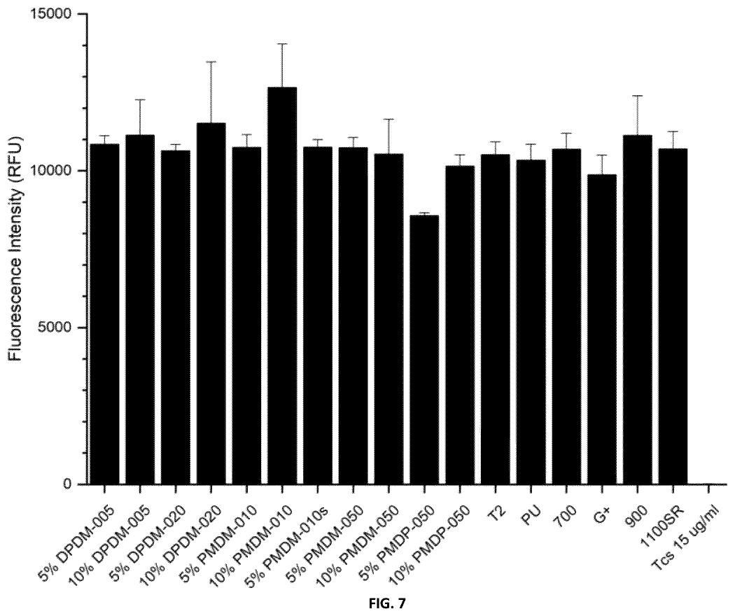

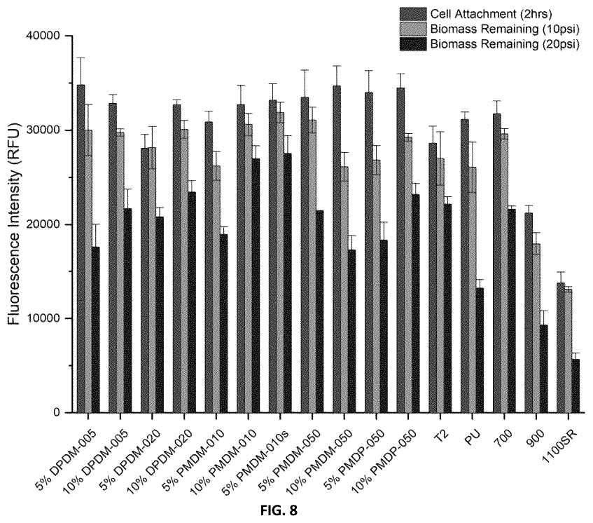

The first assay done was using the microalgae N. incerta. First, the coatings had to be checked for leachate toxicity. For 28 days water was circulated in tanks containing the coatings. After this, the seawater solution that had been exposed to the coatings was removed and N. incerta was grown in this solution. Failure of the N. incerta to grow in this solution would indicate that the coating is toxic, which makes the coating unacceptable for use in a marine environment. For these assays, fluorescence is directly proportional to the cells of algae present. To determine the level of toxicity, G+ was used as the positive control indicating a coating that is non-toxic while Tcs is the negative control indicating a highly toxic coating. As seen in the results in (FIG. 7) the solution for all the coatings exhibits no significant level of toxicity as the algae were able to grow similarly to the positive control. FIG. 8 shows the amount N. incerta that attached to the surface of the coatings in a two-hour time frame. Then, after two hours, a water jet at 10 psi and 20 psi was used to spray each coating for five seconds and the biomass of N. incerta remaining was recorded using fluorescence; most of the coatings, except the commercial coatings, performed similarly to the others. The sample coatings did not exhibit AF/FR properties as the biofilm was able to attach to the surface of the coatings and was not easily removable. The commercial coatings outperform all the sample coatings with the 1100SR performing the best overall for AF/FR properties.

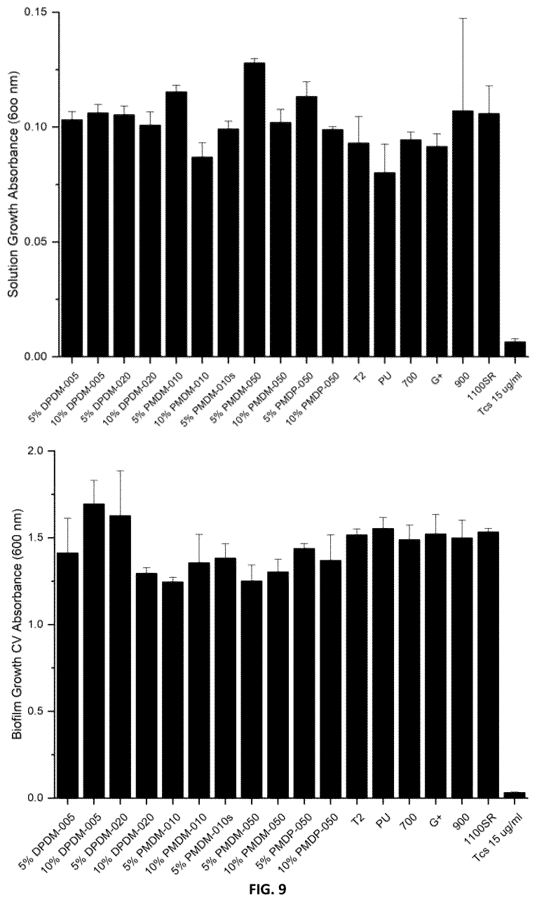

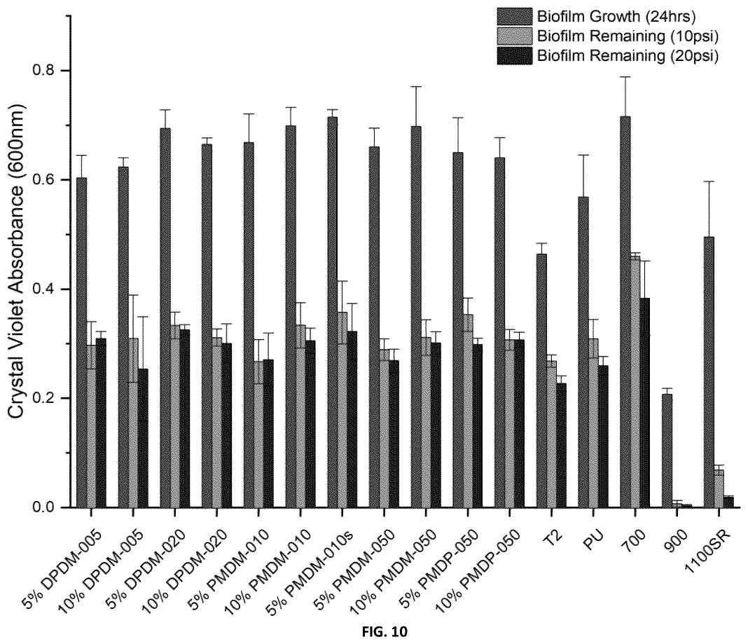

The next assay conducted was with the microorganism Cellulophaga lytica (C. lytica). Again, leachate toxicity tests were first performed. For C. lytica, toxicity was tested on the solution as well as on the coating itself (FIG. 9). Like the first assay performed, the coatings showed no toxicity towards C. lytica in the solution or on the coatings. Similar to the N. incerta, the samples' coatings did not prevent the attachment of C. lytica onto the surface, and none of the samples performed better than the others. Overall, the sample coatings had better releasing properties of C. lytica compared to the N. incerta. Little difference was seen for the removal of C. lytica between the 10 psi and 20 psi water jet. For the N. incerta the difference was more significant. Again, sample coatings did not perform as well as the commercial AF/FR coatings (FIG. 10). The sample coatings performed only slightly better than a plain polyurethane coating. No significant difference was seen between the sample coatings. These results indicate that for microfouling organisms, these coatings do not perform well as AF/FR coatings.

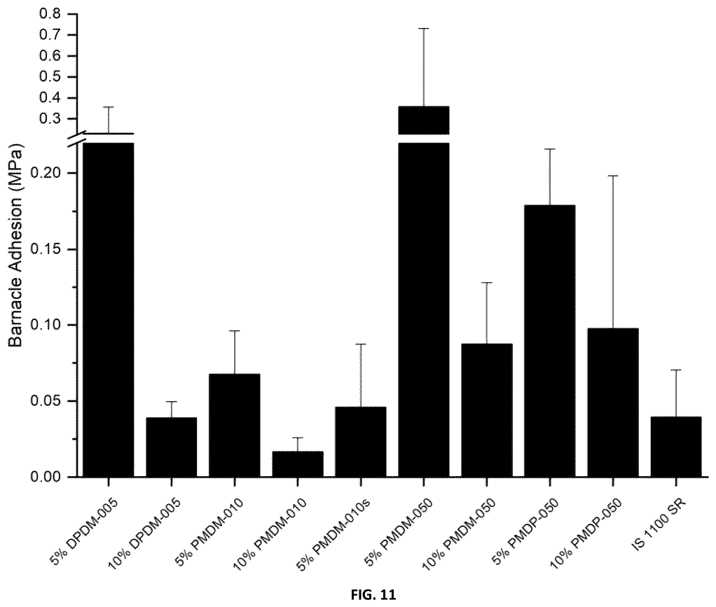

Lastly, the coatings were exposed to the macrofouling organism Amphibalanus amphitrite (barnacles). Barnacle fouling is a significant challenge that is difficult to mitigate due to the barnacle's ability to adhere to many surfaces. Because of the limited availability of live barnacles, only certain coatings could be tested for barnacle adhesion. The coatings were selected based on ice adhesion performance as well as some phenyl-dominant coatings to compare against. In addition to these coatings, three commercial AF/FR coatings were tested. The results can be seen in FIG. 11. The trends seen in the ice-releasing data do not seem to translate to the barnacle adhesion. The PMDM-010 coatings performed well in both, but an interesting result is the low barnacle adhesion force for 10% PMDP-050 considering its low contact angle. While not all the oils that had a high contact angle performed well in the barnacle adhesion, the PMDM-010 coatings did. The higher level of methyl content seems to improve both the contact angle as well as the barnacle adhesion. The 10% PMDM-010 and the 5% PMDM-010s performed similarly with the industry standard Intersleek 1100SR on barnacle removal force.

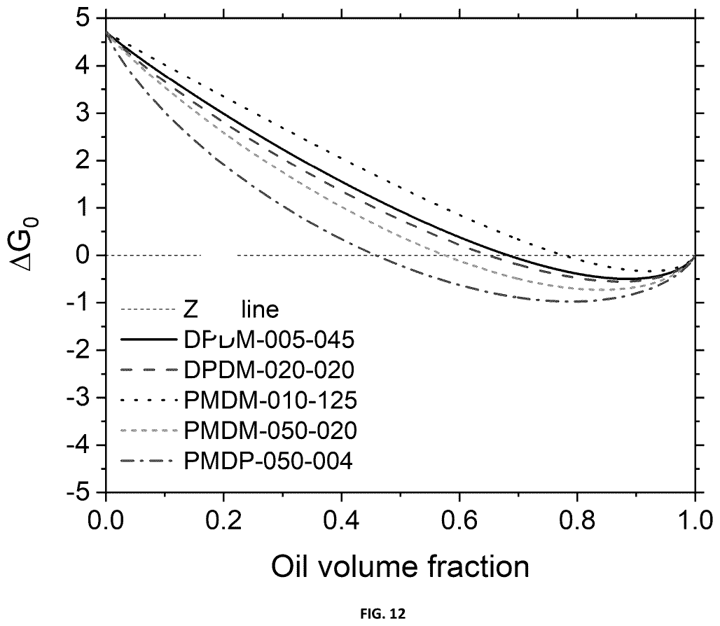

One theory for why the coatings have largely differing surface properties is the miscibility of the oils in the epoxy-siloxane matrix. The miscibility predictions (FIG. 12) directly correlated to the contact angle and ice-releasing data that was collected. It seems that the coatings with oils that are less miscible in the matrix produce a coating that is more hydrophobic and has exceptional ice-releasing properties. Whereas the coatings with oils that are more miscible, produce a coating that is more hydrophilic and has poor ice-releasing properties. This would make sense as a less miscible oil will be forced to the surface of the coating where it can influence the surface properties. The coating with the least miscible oil, PMDM-010, had the lowest ice adhesion and interfacial toughness.

When looking at the miscibility predictions, even the most miscible oil is not miscible until a volume percent of about 40%. The coatings prepared had much less oil additive than this. The hypothesis is that there is a gradient present near the surface of the coating, and the concentration of the oil in that gradient depends on the miscibility of the oil. The more miscible oils will likely be concentrated deeper in the coating, away from the surface where it cannot influence the surface properties. The less miscible oils will likely be concentrated near the surface of the coating. Visual inspection of the coatings supports this hypothesis, as the more miscible oils produce a clear coating, and the less miscible oils phase separate, producing an opaque coating. Initial miscibility predictions are so far aligned with the experimental data collected. These predictions do not account for the presence of solvent or what happens while curing, but they could be a useful tool in identifying how other oils may interact with the coating matrix and influence the surface properties.

### 1.9 Conclusions

In Example 1, an epoxy-siloxane coating was successfully prepared. Upon successful preparation of the base, the coatings were modified with additional polysiloxane oil additives. These oils were added to improve the surface properties of the epoxy-siloxane base, specifically the ice-releasing properties. The additives used were a variety of methyl and phenyl siloxane copolymers that were incorporated into the base coating. The modified coatings were then examined to understand the effects that each oil had on surface properties. The surface characterization was conducted with contact angle, surface energy, and ice adhesion tests. One coating formulation performed well in all experiments conducted. Formulation 5% PMDM-010s yielded increased hydrophobicity and lowered ice adhesion. Marine biofouling was tested by performing laboratory assays using two common microorganisms, Cellulophaga lytica and Navicula incerta, and one macro-organism, Amphibalanus amphitrite (barnacles). Biofouling assays were conducted to draw comparisons between fouling-releasing and ice-releasing properties. For microorganisms, the sample coatings did not perform as well as the commercial coatings. For barnacles some of the coatings containing methyl dominant oils performed equally to Intersleek 1100SR. The best-performing coating was the 5% PMDM-010s. It had the second lowest ice adhesion shear strength and very low interfacial toughness, lower than Van der Waals (0.1 J/m²). The 10% PMDM-010, which also exhibited good ice releasing properties outperformed the Intersleek 1100SR on barnacle adhesion.

### Example 2: Effect of Silicone Oil Additives on Moisture Curable Urea-Siloxane Coating for Anti-Icing Applications

### 2.1 Materials

Methoxyfunctional, methyl-phenyl polysiloxane resin (SILRES SY 231) was provided by Wacker Chemie AG. Methoxyfunctional, phenyl-containing silicone resin (DOWSIL 3074) was obtained from Dow Inc. Polyfunctional aliphatic isocyanate (HDI trimer), Desmodur N 3600 was obtained from Covestro AG. N-butylaminopropyltrimethoxysilane (SIB1932.2) was purchased from Gelest, Inc. All the silicone oils (Table 4) were also purchased from Gelest Inc. Toluene and butyl propionate were purchased from VWR International. Ethyl-3-ethoxypropionate (EEP), methyl ethyl ketone (MEK), and dibutyltin diacetate (DBTDAc) were purchased from Sigma-Aldrich. QD-36 steel panels with a smooth finish (3×6 in², 0.5-mm-thick) were purchased from Q-Lab. Toluene was dehydrated with 4 Å molecular sieves purchased from Sigma Aldrich. All other reagents were used as received.

### 2.2 Synthesis of a Polyurea Resin

Polyurea resin was synthesized following U.S. Pat. No. 8,133,964, the disclosure of which is incorporated herein by reference (Scheme 1). Briefly, 81.6 g of Desmodur N 3600 was dissolved in 60 g of butyl propionate in a 500 ml 3-neck round bottom flask with nitrogen inlet and thermometer. The solution was heated to 50° C. 104.9 g of SIB 1932.2 was added dropwise to the solution with continued mixing. The reaction was exothermic, so the temperature of the solution was maintained between 50-60° C. After the addition was complete, the solution was heated for 30 minutes at 50° C.

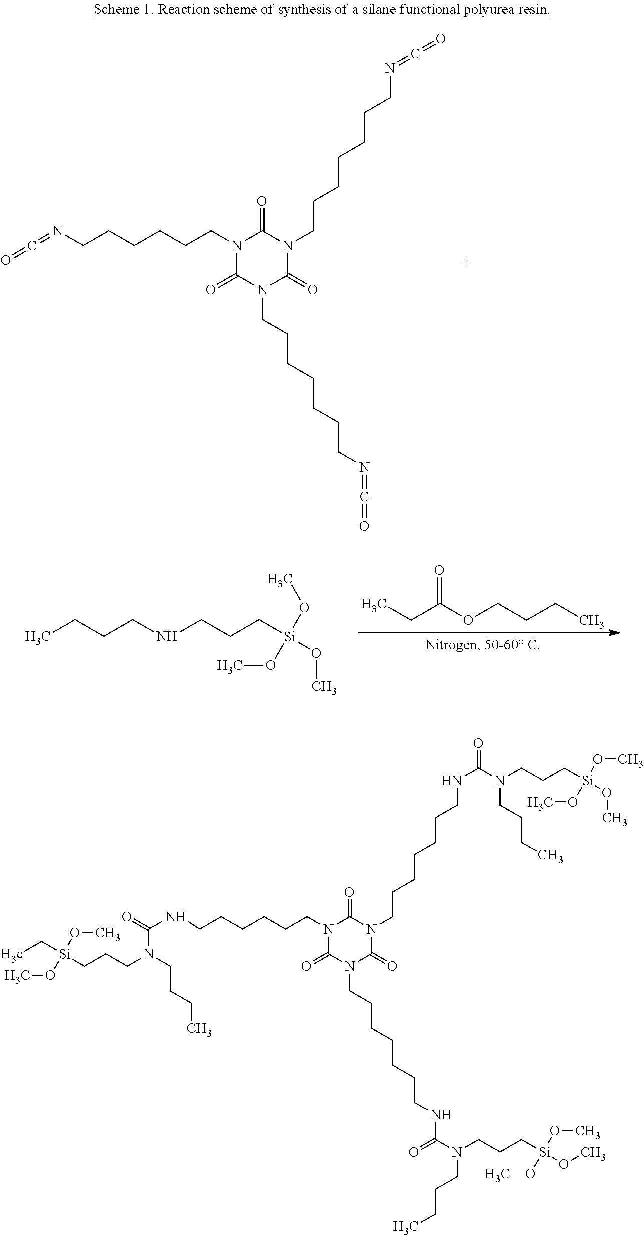

### 2.3 Fourier Transform Infrared (FTIR) Spectroscopy

FTIR spectroscopy was done to determine if all the isocyanates reacted during urea resin synthesis. FTIR measurement was done in Thermo Scientific Nicolet 8700 FTIR.

### 2.4 Percent Solids Determination

The percent solids of the polyurea resin were determined following ASTM 2369. The solids percentage is determined to calculate the amount of volatile organic contents in the resin. Briefly, an empty aluminum pan was weighed. Resin (1-2 g) is put in the pan and weighed again. The pan was put in an oven at 110° C. for 1 hour and then weighed again. Percent solids are then determined by the following equation:

$$Percent solids = \frac{Final weight of pan and resin - Weight of empty pan}{Initial weight of resin}$$

All measurements were done in triplicate.

### 2.5 Coating Formulations and Curing

Coatings were formulated following U.S. Pat. No. 8,133,964 (Scheme 2). Briefly, polyurea resin (12.6 g) was mixed with SILRES SY 231 (2.4 g). EEP (1.5 g) and toluene (0.64 g) were added to the mixture. DBTDAc catalyst was also added at 0.4% of the total solids of the coatings along with different percentages of silicone oils (Table 4). The vial with the mixture was then mixed with a magnetic stirrer at 350 rpm for one hour. After the mixing was complete, the mixture was allowed to settle down for half an hour. Coatings were applied on steel Q-panel using RDS 60 wire rod. The coatings were allowed to cure in the ambient conditions for seven days in a dust-free enclosed cabinet before testing. The coatings were tack-free after overnight curing.

In another set of experiments, coatings were also prepared with DOWSIL 3074 intermediate instead of SILRES SY 231. The weight and preparation method was similar to SILRES SY 231 resin.

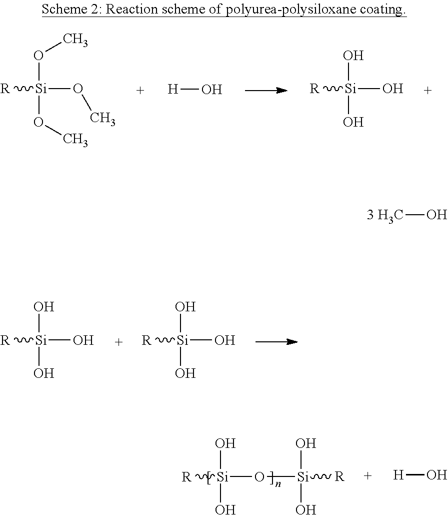

Silicone oils used in these examples are named using the convention: AB-X-XX. ‘A’ represents repeating unit 1 and ‘B’ represents repeating unit 2. ‘X’ represents the ratio of repeating unit 1 and ‘XX’ represents the degree of polymerization. The repeating units can be either diphenyl (DP), dimethyl (DM), or phenylmethyl (PM).

TABLE 4
Silicone oils

| Formulation | Oil | % |
|---|---|---|
| F-0 | Base coat | 0 |
| F-1 | DM-100-027 | 1 |
| F-2 | DM-100-081 | 5 |
| F-3 | DM-100-185 | 1 |
| F-4 | DM-100-185 | 5 |
| F-5 | DM-100-185 | 6.5 |
| F-6 | DM-100-378 | 5 |
| F-7 | PM-100-020 | 1 |
| F-8 | PM-100-020 | 6.5 |
| F-9 | PMDM-010-020 | 1 |
| F-10 | PMDM-010-020 | 5% |
| F-11 | PMDM-010-020 | 6.5 |
| F-12 | PMDM-010-045 | 5 |
| F-13 | PMDM-010-125 | 1 |
| F-14 | PMDM-010-125 | 5 |
| F-15 | PMDM-010-125 | 6.5 |
| F-16 | PMDM-010-125 | 10 |
| F-17 | PMDM-050-020 | 1 |
| F-18 | PMDM-050-020 | 6.5 |
| F-19 | PMDM-060-035 | 5 |
| F-20 | PMDP-050-004 | 5 |

Initially, ice adhesion tests were done for 5% oil addition based on the solids content of the coating. The formulation that gave lower ice adhesion results was tested further with 1%, 6%, and 10%; all the oils were tested for 5%. Coatings that had defects are not included in the formulations. Coatings with 10% oil resulted in defects for most of the formulations, so they were not considered for any further analysis. Diphenyl silicone oils were incompatible with the matrix, so they were not considered in the formulation.

### 2.6 Ice-Adhesion Measurement

There are not yet universally accepted ice adhesion test procedures and different studies use different ways of measurements [26-28]. In brief, the measurement setup consisted of a cooling unit, a test stand with a cooling flat plate, a pushing force gauge that can move back and forth in one direction, and a cylindrical silicon mold for ice growth. The cooling unit was set at −20° C. The panel with the cured coating was fixed on top of the cooling plate and mold was placed on top of the coating. Distilled water was put in the mold and allowed to freeze completely. The time of freezing varied between different coatings between 50-80 minutes. Once the ice was formed, the mold was taken out. The clearance between the coated plate and the tip of the force gauge was set to a minimum (^{˜}1 mm). Ice was pushed horizontally in the middle at a speed of 10 mm per minute and a force required to dislodge the ice from the surface was noted. Each coating was tested for triplicates and an average value was noted. The lower the force required, the higher the icephobicity of the coating.

### 2.7 Surface Characterization

Surface characterization of the coating was performed using Atomic Force Microscopy (AFM). The sample panel was placed on the sample holder of the Oxford Asylum Jupiter XR microscope. A silicon cantilever (AC240) probe was calibrated and used for scanning the sample. Height and phase images were gathered from the scans.

### 2.8 Contact Angle and Surface Energy Measurements

All the coatings were characterized for water contact angle (WCA), methylene iodide contact angle (MICA), and surface free energy using Kruss® DSA 100 (Drop Shape Analyzer). Surface-free energy was calculated using the Owens-Wendt method. All the measurements were quantified with Kruss® Advance software.

### 2.9 Mechanical Characterization

The film thickness of the coatings was measured with a Byko-Test 8500 coating thickness gauge. The gauge is based on the principle of electromagnetic induction. The gauge was zeroed against the standard and calibrated, then the thickness of the coating was measured at different places on the coating.

Pencil hardness was done following ASTM D 3363. The pencil with the hardest lead was dragged into the coating surface at a 45° angle and the process was repeated with lower hardness pencils. Gouge resistance was noted with the hardest pencil that will not cut or tear film and mar resistance was noted with the hardest pencil that will not make a scratch.

König pendulum hardness test was done following ASTM D 4366 in which the panel was loaded in the machine and time was counted for the pendulum to go from 6° to 3º angle. The process was repeated for different places on the coating.

Impact tests of the coatings were performed following ASTM D 2794 using a falling dart or Gardner impact tester. The front and reverse impact strength of the coatings were noted based on the coating side on the Q-panel. The maximum drop height of the 4 lb weight load in the tester was 43 inches. The coated Q-panel was placed (both the front coated side and back side) in the tester and the maximum weight was dropped. The process was repeated with decreasing height until no deform was seen on the coating surface upon impact. The impact value was then noted as the product of the drop height and weight of the load.

A crosshatch adhesion test was done following ASTM D 3359. The coating was crosshatched using a crosshatch cutter kit and taped with cross-hatch adhesion tape. The tape was then removed and the peeling effect on the coating was observed. Based on the extent of peeling on the coating, the result was matched with the standard.

The extent of solvent resistance of the coatings was tested with MEK double rubs following ASTM D 5402. A hammerhead was wrapped with cheesecloth and soaked MEK. The hammer was then rubbed back and forth, recording the double rubs until the coating failure was observed. Coating failure occurred when the substrate was exposed. The cheesecloth was soaked after every 50 rubs.

A conical mandrel test was done following ASTM D 522 to test the flexibility of the coating. The coated panel was loaded in the conical mandrel and bent. The panel was then inspected for any cracks in the coating.

### 2.10 Results and Discussion

Ice accretion on surfaces of airplanes, ships, and wind turbines has operational safety and reliability issues with potential catastrophic failures. Anti-icing or in general, ice-shedding coatings are a desired choice to overcome the challenges posed by ice accretion on these surfaces. The coatings that are to be applied on these surfaces should be easy to apply and provide good mechanical properties including excellent adhesion, impact resistance, durability, and flexibility along with low ice adhesion properties. A single component moisture curable polyurea-siloxane coating has shown good mechanical properties along with safety and ease of application. The backbone of the coating is formed by aliphatic polyurea linkages, and the polymer crosslinks via the polycondensation of the alkoxy groups present in the siloxane and the silane groups of the polyurea resin. The surface properties of the coatings such as ice adhesion and surface-free energy are expected to be reduced by silicone oil additives on the base coating formulation.

### 2.11 Poly-Urea Resin

The synthesis of N-substituted urea resin was confirmed by FTIR. The disappearance of the isocyanate (NCO) peak at around (2250 cm⁻¹) confirmed the reaction of the NCO group. The solids content of resin was 76%.

### 2.12 Coatings Characterization

Initially, a base coating (no oil additives) without any catalyst was prepared. After two weeks of ambient curing, MEK double rubs were tested for chemical resistance of the coating which was less than 50. To accelerate the curing and improve chemical resistance, 0.4% DBTDAc was added to the formulation. After one week of curing the coating showed 300+ MEK double rubs and after two weeks of curing, it showed 400+ MEK double rubs. MEK double rubs were lower with lower humidity in the ambient conditions.

### 2.13 Mechanical Measurements

The result of mechanical tests for coatings with different silicone oil additives is given in Table 5. The results showed that the coatings had excellent adhesion, very high flexibility, impact resistance, chemical resistance, and good hardness. The addition of silicone oils did not impact the mechanical properties of the coatings to a great extent. The cross hatch adhesion test showed that the coating had very good adhesion to the steel substrate. The hydroxyl end groups provided strong hydrogen bonding with the substrate. All coatings with different oil additives passed the conical mandrel bend test without any cracks. This shows that the coating is very flexible, and the addition of oils does not impact its flexibility. The aliphatic polymeric backbone and polysiloxane provided the coating with the necessary flexibility and high impact resistance which makes the coating very durable. Coatings with PMDM-010-125 silicone oil (F-13 to F-16) were slightly brittle as seen by lower impact resistance on the back side of the panel (without coating). The base coating showed moderate pencil hardness of 1H. The addition of silicone oils made the coatings slightly softer with most formulations having a pencil hardness of 1B. Pencil hardness is a qualitative test and shows the hardness of the bulk coating. The pendulum hardness test showed a similar trend. Pendulum hardness gives the measure of surface hardness. The addition of oils reduced the hardness which means oil came to the surface of the coating.

TABLE 5
The results of mechanical tests for coatings with different silicone oils at different percentages

| | Film | | | | | | Impact resistance | |
|---|---|---|---|---|---|---|---|---|
| | thickness | Pendulum | Pencil | MEK | Conical | Crosshatch | (lbs. in) | |
| Formulation | (μm) | hardness (s) | hardness | double rubs | mandrel | adhesion | Front | Back |
| F-0 | 57.95 ± 7.83 | 85.33 ± 2.52 | 1H | 245 | Pass | 5B | 164+ | 164+ |
| F-1 | 48.63 ± 3.69 | 107.25 ± 2.06 | HB | 400+ | Pass | 5B | 164+ | 164+ |
| F-2 | 48.78 ± 3.07 | 40 ± 14.11 | 1B | | Pass | 5B | 164+ | 164+ |
| F-3 | 51.0 ± 4.82 | 74.67 ± 1.15 | 1B | | Pass | 5B | 164+ | 164+ |
| F-4 | 48.8 ± 8.54 | 44.2 ± 9.98 | 1B | 305 | Pass | 5B | 164+ | 164+ |
| F-5 | 49.55 ± 3.82 | 25.33 ± 6.03 | 1B | | Pass | 5B | 164+ | 164+ |
| F-6 | 46.13 ± 3.89 | 26 ± 10.15 | HB | | Pass | 5B | 164+ | 164+ |
| F-7 | 50.25 ± 5.88 | 43.67 ± 6.66 | 1B | 160 | Pass | 5B | 164+ | 164+ |
| F-8 | 48.98 ± 10.31 | 57.33 ± 2.31 | 2B | 295 | Pass | 5B | 164+ | 164+ |
| F-9 | 51.52 ± 2.89 | 88.0 ± 3.0 | HB | 220 | Pass | 5B | 164+ | 164+ |
| F-10 | 61.86 ± 7.37 | 39.67 ± 13.05 | 2H | 205 | Pass | 5B | 164+ | 164+ |
| F-12 | 48.23 ± 5.16 | 65.33 ± 7.77 | HB | | Pass | 5B | 164+ | 164+ |
| F-13 | 55.47 ± 7.48 | 34.33 ± 5.69 | HB | 395 | Pass | 5B | 164+ | 114 |
| F-15 | 51.27 ± 4.63 | 94.67 ± 4.04 | 1B | 265 | Pass | 5B | 164+ | 110 |
| F-16 | 51.92 ± 2.9 | 64.33 ± 14.19 | 1H | 140 | Pass | 5B | 164+ | 125 |
| F-17 | 50.77 ± 5.35 | 51.67 ± 7.09 | HB | 370 | Pass | 5B | 164+ | 164+ |
| F-18 | 60.46 ± 6.96 | 45.0 ± 6.08 | 1H | 95 | Pass | 5B | 164+ | 164+ |
| F-19 | 50.25 ± 4.59 | 84.67 ± 4.04 | 1B | 190 | Pass | 5B | 164+ | 164+ |
| F-20 | 50.23 ± 4.16 | 82.0 ± 5.29 | 1B | 245 | Pass | 5B | 164+ | 164+ |

### 2.14 Ice Adhesion

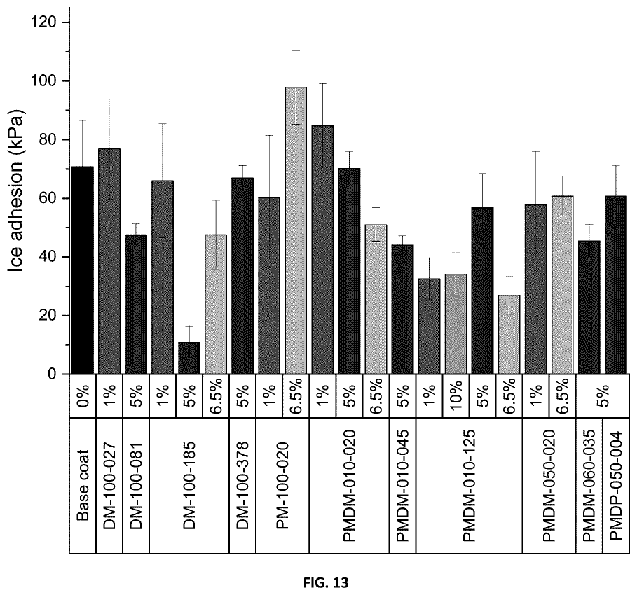

The result of the ice adhesion test showed a reduction in ice adhesion strength for most of the tested coatings (FIG. 13). Ice adhesion is the measure of shear force/stress required to dislodge the ice from the coating surface. It is hypothesized that the addition of silicone oil additive in the coating formulation created an interfacial slippage layer from the oil which leached out of the coating matrix to the surface. Since the oils had very low shear modulus, they provided ease in the removal of ice. The base coating without any oil additives showed icephobic characteristics with less than 100 kPa ice adhesion strength. One possible reason for this may be the presence of siloxanes on the surface of the coating. Siloxanes are known to be hydrophobic which also helps in their icephobic properties. Among the oil additives, DM-100-185 and PMDM-010-125 showed the lowest ice adhesion strength compared to other oils. F-4 (5% DM-100-185) showed super-icephobic properties with less than 10 kPa ice adhesion strength. One reason might be that PDMS oils are known to be very hydrophobic. Compared to other PDMS oils, DM-100-185 showed the lowest ice adhesion strength. The molecular weight of the oil also influenced the ice adhesion property. Phenyl methyl silicone oil PMDM-010-125 at 1% (F-13) and 6.5% (F-15) also showed low ice adhesion strength. One similarity of this oil with the PDMS oil with the lowest ice adhesion strength is its molecular weight. DM-100-185 has 13650 MW while PMDM-010-125 has 10000 MW.

### 2.15 Contact Angle and Surface Energy

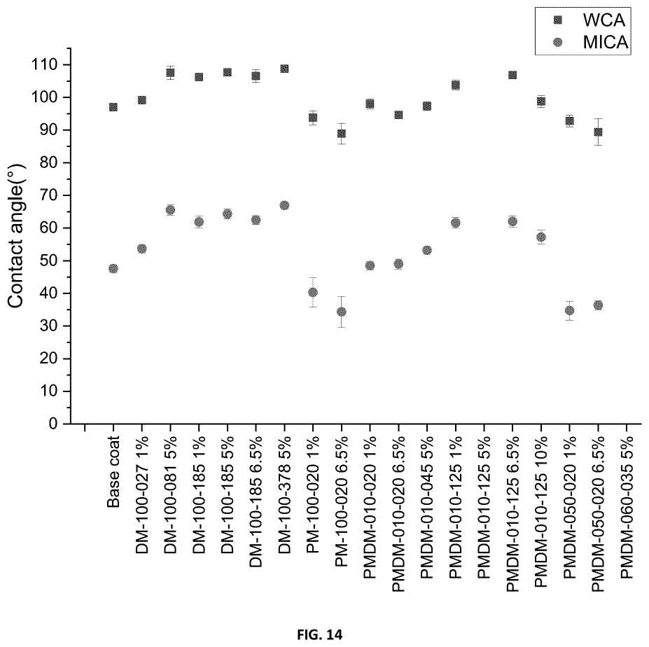

Measurement of contact angles gives information on hydrophobicity and surface free energy of the surface which is very important in understanding the surface characteristics of the coatings. Water is used as a polar liquid and methylene iodide is a non-polar liquid for the measurement of contact angles. The result of the contact angle measurement is given in FIG. 14. The base coat without any oil additives showed a hydrophobic nature with a greater than 95° water contact angle. The addition of PDMS oil showed an increase in both WCA and MICA. Both WCA and MICA decreased with the phenylmethyl oils. However, there was an increase in both WCA and MICA when phenyl methyl dimethyl oils having 10% phenyl methyl content were used. When the phenylmethyl content of the oil increased, both WCA and MICA decreased. Since phenyl groups are more polar than methyl groups, phenyl groups tend to be less hydrophobic than methyl groups. This is reflected in the contact angle results.

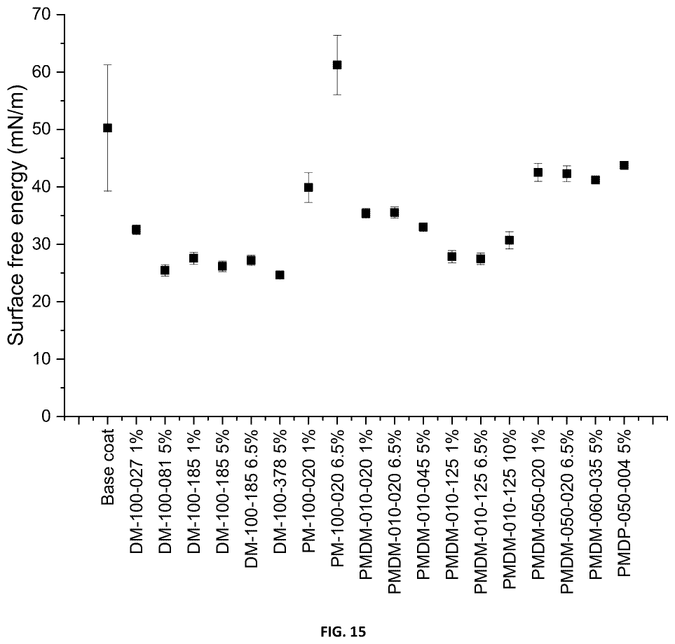

To determine the effect of oil additives on surface properties, the surface-free energy of the coatings was also determined (FIG. 15). The use of the silicone oil additives showed a reduction in the surface free energy of the coatings. Since the surface energy of the coatings with silicone oils was lower than the surface free energy of the base coating, it showed the addition of the oils reduced the surface free energy of the coatings.

The results showed both a positive correlation between the contact angles and ice adhesion strength, and between the surface free energy and ice adhesion strength. The results also showed a positive correlation between the surface free energy and contact angles This means that hydrophobic coatings were also shown to have an icephobic property, and that both the hydrophobic and icephobic surfaces showed lower surface free energies.

### 2.16 Atomic Force Microscopy

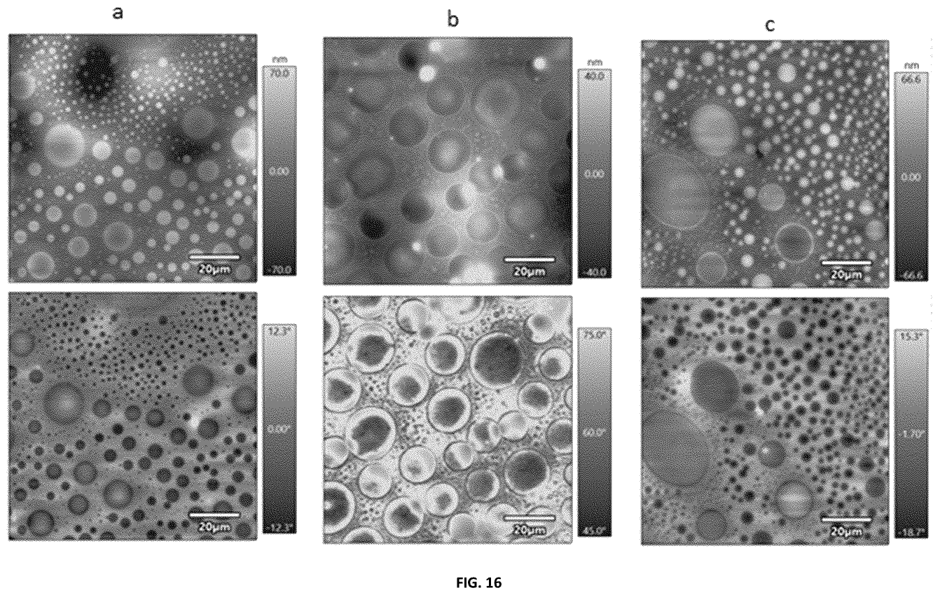

AFM images were taken for coatings with different oil additives to characterize the surface of the coatings (FIG. 16). The images showed that coatings with oil additives have two distinct domains consisting of oil on the surface of the base matrix. This showed that oil leaches out of the coating. For F-4, the size of the domains of silicone oil is not uniform. The intensity of smaller-size domains was higher than the large-size domains. The oils were distributed throughout the coatings and no agglomeration was seen. For F-13, the size of the domain of silicone oil was larger and somewhat uniform. However, once the oil content was increased from 1% in F-13 to 6.5% in F-15, the size of the domain of silicone oil changed and more of the smaller size domains with few larger size domains were present.

2.17 Coatings Formulated with DOWSIL Resin

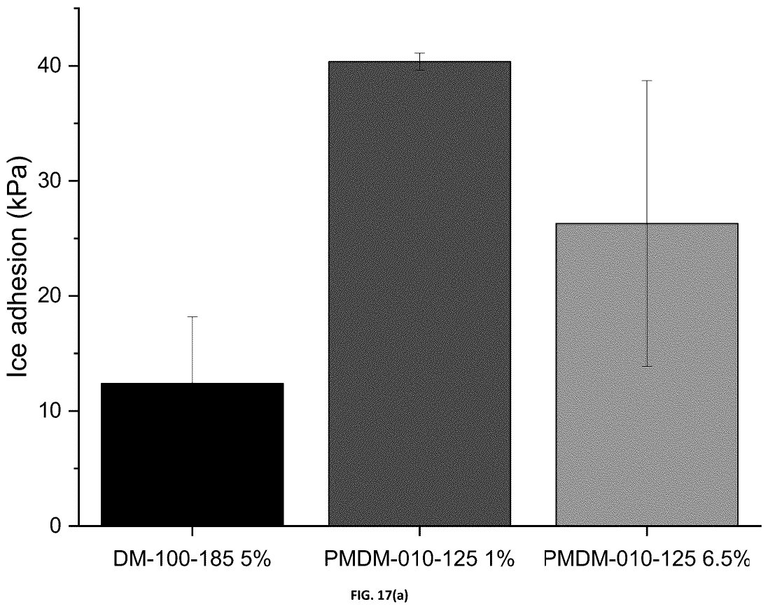

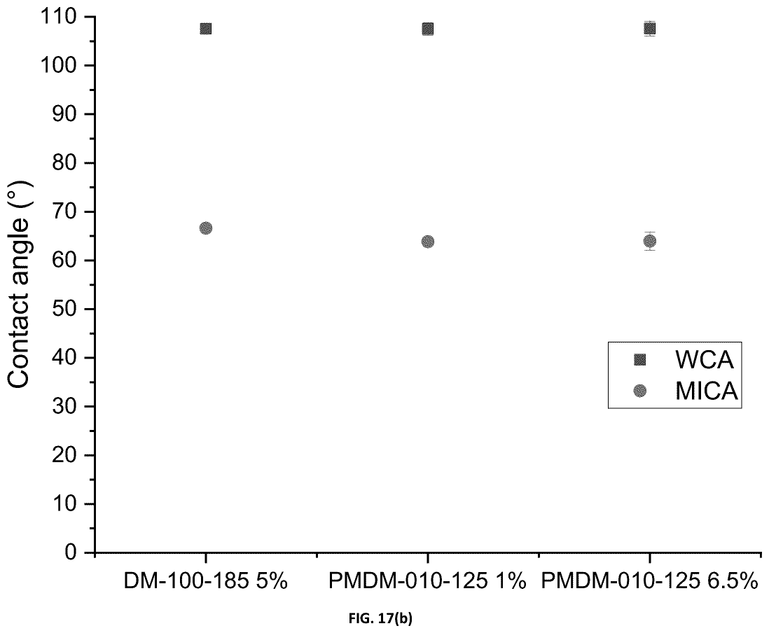

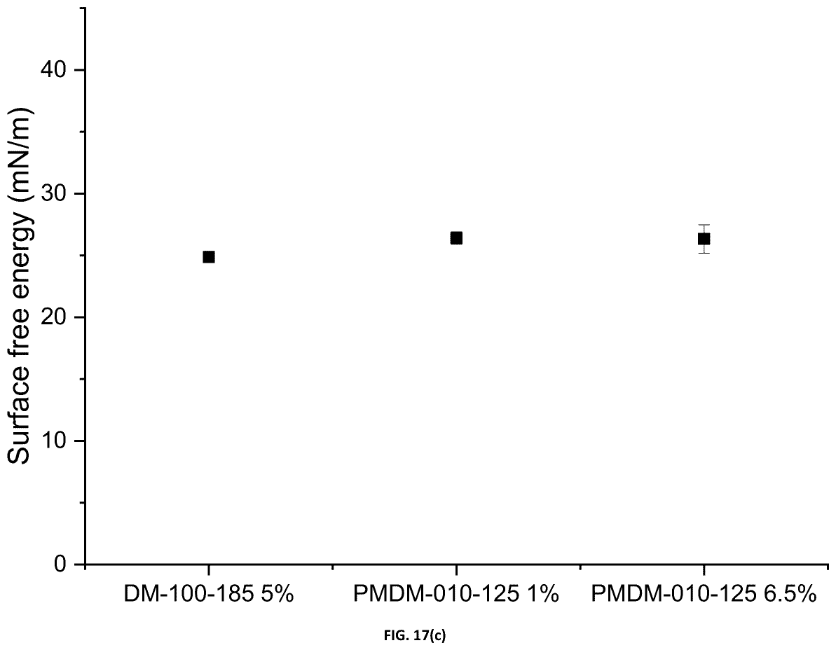

Formulations F-4, F-13, and F-15 were also prepared with DOWSIL 3074 resin. The results of ice adhesion, contact angles, and surface free energy are given in FIGS. 17(a), 17(b), and 17(c). The results were comparable with formulations containing SILRES SY 231 resin.

### 2.18 Conclusions

The base coating matrix has phenyl methyl siloxane moieties on its backbone. So, phenyl methyl oils were expected to be more compatible while dimethyl and diphenyl oils would be less compatible with the matrix. Diphenyl oils were not compatible with the matrix as expected, but dimethyl oils were also compatible with the matrix. F-4 with dimethyl oil gave the lowest ice adhesion among all the formulations while F-15 with phenyl methyl oil gave the second lowest ice adhesion result. The molecular weight of the silicone oils also plays some role in the performance of the coatings. Lower molecular weight oils tend to give higher ice adhesion. However, once the oil reaches a certain molecular weight, the ice adhesion increased again. So, there is an interplay between the molecular weight of the oils and the matrix that governs the surface properties of these coatings.

The lowest ice adhesion results obtained for F-4, F-13, and F-15 are very promising. The mechanical properties of these coatings showed very good adhesion and toughness property which are essential for many commercial applications.

The claimed invention is:

1. A curable coating composition comprising:
a) at least one siloxane-modified resin composition;
b) at least one silicone oil additive;
c) optionally, at least one further additive;
d) optionally, at least one catalyst; and
e) optionally, at least one solvent.

2. The curable coating composition of claim 1, wherein the siloxane-modified resin composition is selected from an epoxy-siloxane resin composition, polyurea-siloxane resin composition, and mixtures thereof.

3. The curable coating composition of claim 2, wherein the epoxy-siloxane resin composition comprises:
a1) at least one epoxy resin;
a2) at least one silane compound; and
a3) at least one silicone resin.

4. The curable coating composition of claim 3, wherein the at least one epoxy resin (a1) is selected from bisphenol-A epoxy resin, glycidyl ethers of bisphenol-A, bisphenol-F, tetramethyl bisphenol-A, tetramethyl bisphenol-F, hydrogenated bisphenol-A, phenolic resin, butane diol, hexane diol, cyclohexane dimethanol, trimethylolpropane, and mixtures thereof.

5. The curable coating composition of claim 4, wherein the at least one epoxy resin (a1) is a bisphenol-A epoxy resin.

6. The curable coating composition of claim 5, wherein the at least one bisphenol-A epoxy resin has a viscosity at 25° C. ranging from about 1800-2500 cps.

7. The curable coating composition of claim 4, wherein the at least one bisphenol-A epoxy resin is hydrogenated.

8. The curable coating composition of claim 3, where the at least one silane compound (a2) is selected from (3-aminopropyl) trimethoxy silane, methyltrimethoxysilane, and N-butylaminopropyltrimethoxysilane.

9. The curable coating composition of claim 3, wherein the at least one silicone resin (a3) is a methoxy-functional silicone resin.

10. The curable coating composition of claim 9, wherein the methoxy-functional silicone resin has a viscosity at 25° C. of about 90-180 sCt and a molecular weight average ranging between 900-1900 Daltons.

11. The curable coating composition of claim 2, wherein the polyurea-siloxane resin composition comprises:
b1) at least one alkoxy silane functional polyurea resin; and
b2) at least one silicone resin.

12. The curable coating composition of claim 11, wherein the polyurea resin comprises the reaction product of:
b1.1) at least one polyisocyanate resin; and
b1.2) at least one amino-functional alkoxy silane and, optionally, at least one difunctional amine,
wherein the components (b1.1) and (b1.2) are reacted under conditions sufficient to form the alkoxy silane functional polyurea resin.

13. The curable coating composition of claim 12, wherein the at least one amino-functional alkoxy silane is substituted at the at the N-position with a group selected from C3-C6 alkyl, cyclohexyl, and phenyl.

14. The curable coating composition of claim 13, wherein the at least one amino-functional alkoxy silane is selected from the group consisting of N-butyl-3-aminopropyltrimethoxysilane, N-butyl-3-aminopropylmethyldimethoxysilane, N-butyl-3-aminopropyltriethoxysilane, N-ethyl-3-aminopropyltriethoxysilane, N-cyclohexyl-3-aminopropyltrimethoxysilane, N-phenyl-3-aminopropyltrimethoxysilane, N-hexyl-3-aminopropyltrimethoxysilane, N-pentyl-3-aminopropyltrimethoxysilane, N-isopropyl-3-aminopropyltrimethoxysilane, and N-isobutyl-3-aminopropyltrimethoxysilane.

15. The curable coating composition of claim 12, wherein the difunctional amine has the structure NR¹R², where each of R¹ and R² is independently an aliphatic, cycloaliphatic, or aromatic group.

16. The curable coating composition of claim 12, wherein components (b1.1) and (b1.2) are reacted in the presence of a solvent.

17. The curable coating composition of claim 16, wherein the solvent is selected from acetone, methyl ethyl ketone, methyl amyl ketone, n-butyl acetate, t-butyl acetate, propylene glycol monomethyl ether acetate, butyl propionate, toluene, xylenes, benzene, tetrahydrofuran, diethyl ether, methyl t-butyl ether, ethyl ethoxy propionate, N-methyl pyrrolidone, N-ethyl pyrrolidone, cyrene, and mixtures thereof.

18. The curable coating composition of claim 11, wherein the at least one alkoxy silane functional polyurea resin (b1) is a trimethoxysilane-terminated N-butyl urea resin.

19. The curable coating composition of claim 18, wherein the at least one alkoxy silane function polyurea resin (b1) is 1,1′,1″-(6,6′,6″-(2,4,6-trioxo-1,3,5-triazinane-1,3,5-triyl)tris(hexane-6,1-diyl))tris(3-butyl-3-(trimethoxysilyl) propyl) urea).

20. The curable coating composition of claim 11, wherein the at least one silicone resin (b2) may be the same or different as the at least one silicone resin (a3).

21. The curable coating composition of claim 11, wherein the at least one silicone resin is a methoxy-functional silicone resin.

22. The curable coating composition of claim 21, wherein the methoxy-functional silicone resin has a viscosity at 25° C. of about 90-180 sCt and a molecular weight average ranging between 900-1900 Daltons.

23. The curable coating composition of claim 1, wherein the at least one siloxane-modified resin composition (a) is present in the coating composition in an amount ranging from about 40-99.9 wt. %, based upon the total weight of the coating composition.

24. The curable coating composition of claim 1, wherein the at least one silicone oil additive (b) is selected from a siloxane copolymer, a siloxane homopolymer, and mixtures thereof.

25. The curable coating composition of claim 24, wherein the siloxane copolymer is selected from poly(dimethyl siloxane) (PDMS), poly(diphenyl siloxane) (PDPS), poly(phenyl-methyl siloxane) (PPMS), copolymers poly(diphenyl-dimethyl siloxane) and poly(phenylmethyl-dimethyl siloxane), and mixtures thereof.

26. The curable coating composition of claim 25, wherein the poly(diphenylsiloxane-dimethylsiloxane) is selected from 4-6 wt. % diphenyl content (3,500-4,000 g/mol⁻¹), 18-22 wt. % diphenyl content (1,600-2,400 g/mol⁻¹), and mixtures thereof.

27. The curable coating composition of claim 25, wherein the poly(phenylmethyl-dimethylsiloxane) is selected from 8-12 wt. % phenylmethyl content (1,500-1,600 g/mol⁻¹), 48-52 wt. % phenylmethyl content (2,200 g/mol⁻¹), 45-55 wt. % phenylmethyl content (600-800 g/mol⁻¹), and mixtures thereof.

28. The curable coating composition of claim 24, wherein the siloxane homopolymer is selected from a poly(phenylmethylsiloxane), a poly(dimethylsiloxane), and mixtures thereof.

29. The curable coating composition of claim 28, wherein the poly(phenylmethylsiloxane) is selected from phenylmethylsiloxane (2,500-20,000 g/mol⁻¹).

30. The curable coating composition of claim 28, wherein the poly(dimethylsiloxane) is selected from dimethylsiloxane (1,000-20,000 g/mol⁻¹).

31. The curable coating composition of claim 24, wherein the at least one silicone oil additive (b) is selected from poly(phenylmethylsiloxane-dimethylsiloxane), poly(dimethylsiloxane), and mixtures thereof.

32. The curable coating composition of claim 31, wherein the at least one silicone oil additive (b) is selected from poly(phenylmethylsiloxane-dimethylsiloxane), poly(dimethylsiloxane), and mixtures thereof.

33. The curable coating composition of claim 1, wherein the silicone oil additive (b) is present in the coating composition in an amount ranging from about 0.01-60 wt. %, based upon the total weight of the coating composition.

34. The curable coating composition of claim 1, wherein the at least one further additive (c) is a hardener additive.

35. The curable coating composition of claim 34, wherein the hardener additive is selected from methyltrimethoxysilane, tetramethoxysilane, tetraethoxysilane, and mixtures thereof.

36. The curable coating composition of claim 1, wherein the at least one catalyst (d) is selected from dibutyltin diacetate, dibutyl tin dilaurate, and mixtures thereof.

37. The curable coating composition of claim 1, wherein the at least one catalyst (d) is present in the coating composition in an amount ranging from about 0.01-10%, based upon the total solid contents of the coating composition.

38. The curable coating composition of claim 1, wherein the at least one solvent (e) is selected from hydrocarbon, ester, ketone, ether, ether-ester, alcohol, or ether-alcohol type solvents, and mixtures thereof.

39. The curable coating composition of claim 1, wherein the at least one solvent (e) is selected from benzene, toluene, xylene, aromatic 100, aromatic 150, acetone, methylethyl ketone, methyl amyl ketone, butyl acetate, t-butyl acetate, tetrahydrofuran, diethyl ether, ethyl-3-ethoxypropionate (EEP), isopropanol, butanol, and mixtures thereof.

40. The curable coating composition of claim 1, wherein the at least one solvent (e) is present in the coating composition in an amount ranging from about 0.01-90 wt. %, based upon the total weight of the coating composition.

41. A cured coating composition, comprising the curable coating composition of claim 1.

42. An article of manufacture, comprising:
a) a substrate; and
b) the curable coating composition of claim 1 applied on at least a part of the surface of the substrate.

43. The article of manufacture of claim 42, where the substrate is steel.

44. A method of coating a substrate comprising:
providing a substrate;
applying the curable coating composition of claim 1 on at least a part of the surface of the substrate to form a coated substrate; and
curing the coated substrate under conditions sufficient to cure the curable coating composition.

45. The method of claim 44, wherein the coated substrate is cured at ambient conditions.

46. The method of claim 44, wherein the coated substrate is cured for about 1-72 hours.

47. The method of claim 44, wherein the substrate is steel.

48. The method of claim 44, wherein the substrate is coated with another coating before application of the curable coating composition.
